(19) United States
(12) Patent Application Publication
(10) Pub. No.: US 2010/0304920 A1
(43) Pub. Date: Dec. 2, 2010

(54) Hybrid Assembly , A Hybrid Power-Train , And A Method For Operating A Selectively Movable Assembly

(76) Inventor: Bernard Joseph Simon, Troy, MI (US)

Correspondence Address: Bernard Joseph Simon, 3831 Eastbourne, Troy, MI, 48084, US

(21) Appl. No.: 12/455,118

(22) Filed: May 28, 2009

(51) Int. Cl. B60W 10/04; B60W 20/00; B60W 10/10

(52) U.S. Cl. 477/3; 475/5; 477/110; 903/910; 903/930

(57) ABSTRACT

An improved hybrid powertrain incorporating a flywheel which provides a mechanical power path and an electrical power path wherein the flywheel can be accelerated or decelerated with or without generating a torque on the output shaft. The design is not only suitable for high energy flywheels, but also for low energy flywheels sized to handle transient power requirements (acceleration and deceleration), thus lowering the power requirement for the prime energy source. As such, the system is ideal for electric vehicles, fuel cell vehicles, and series hybrid vehicles as the prime power source is fractionally sized.

### GENERAL BACKGROUND

1. Field of the Invention

The invention generally relates to a hybrid type of selectively movable assembly, such as by way of example and without limitation a hybrid type of automobile, to a hybrid type of power train which may be operatively placed within a selectively movable assembly, to a method for operating a selectively movable assembly and, more particularly, to a hybrid type of selectively movable assembly having a new and improved hybrid type of power train which allows the selectively movable assembly to be operated in a new and efficient manner.

2. Background of the Invention

There generally exists a desire in the United States to reduce reliance on fossil fuels. Automakers strive to meet this goal by working to continuously improve the fuel efficiency of existing power-trains, developing new systems such as hybrids, and by developing fuel-cell or battery-powered systems which require no fossil fuels. The term “hybrid” means, in this description, a type of system which generally uses two distinct types of propulsion strategies. One non-limiting example of a hybrid automobile is one that uses gasoline and electricity for selective movement or propulsion.

The developmental challenges to the various alternate designs include rivaling the power, performance, and range of a gasoline engine at a reasonable cost. A 160 hp (which “hp” means horse power) engine can be replaced by a 160 hp electric motor, but it requires a 160 hp power supply. Battery packs of sufficient size can be created, but they are heavy, costly, slow to charge, and have a life which is generally and inversely proportional to the amount of cycling (charging and discharging) which the battery undergoes. A 160 hp fuel cell is not currently ready for the market at a reasonable price, and there is little infrastructure to support such a system. To better understand powertrain requirements, it is useful to perform a simple analysis on a hypothetical system.

FIG. 1 illustrates a representative performance requirement for a modern vehicle. Particularly, FIG. 1 represents an output vehicular speed trace 10 which graphically shows the operational interrelationship between the speed of the vehicle and elapsed time as the vehicle is operated from a “rest” or “zero speed” state. Particularly, FIG. 1 contains an acceleration portion 1, a steady-state speed portion 2, and a deceleration portion 3. From the trace 10, it can be observed that this representative vehicle accelerated from rest to a speed of about 60 miles per hour in about 8 seconds, and from a speed of about 60 miles per hour to a speed of about 75 miles per hour in about 2 seconds. Vehicle weight and aerodynamic drag data can be used along with a performance curve such as FIG. 1 to generate a power train performance requirement. It is understood, by those or ordinary skill in the relevant art, that curves or traces, such as that which is shown in FIG. 1 represents idealized targets, and that an actual design might deviate from the desired or representative graph, such as that which is shown in FIG. 1. For example, the desired time to go from rest or 0 miles per hour to a speed of about 60 miles per hour, might be met, but the time to go from a speed of 60 miles per hour to a speed of 80 miles per hour might not be met. It is also understood that FIG. 1 represents performance in an idealized environment with no headwind, tailwind, grade to the road, or any other attribute which would affect vehicle performance.

FIG. 2 generally illustrates the power train output power required to enable a representative vehicle to meet the performance curve 10 of FIG. 1. Reference or graphical portion 20 represents the total output power required at the wheels of the automobile. Reference or graphical portion 21 represents the portion of the total power 20 required to accelerate or decelerate the mass of the vehicle. Reference or graphical portion 22 represents the portion of the total power required to overcome rolling resistance. As can be seen, in this representative or idealized scenario, most of the generated propulsion type power is required to accelerate the mass of the vehicle. Very little power is required to overcome rolling resistance and maintain a desired speed. In a non-limiting example, the peak of the total power 20 is 209 kW, the peak of the mass acceleration/deceleration power 21 is 185 kW, and the peak of the rolling-resistance power 22 is 24 kW. Also note that during the deceleration step 3, total output power 20 and inertial deceleration power 21 are both negative. During deceleration portion 3, reference 20 represents the braking effort required to slow the vehicle, and reference 21 represents the power generated by the deceleration of the vehicle mass. In this example, the peak power generated is 185 kW. The following table summarizes the system requirements for operating this representative vehicle in the afore-described desired manner:

Power (kW)

| Description | Reference | Max | Min |
|---|---|---|---|
| Total Power | 20 | 209 | −161 |
| Mass-Acceleration Power | 21 | 185 | −185 |
| Rolling Resistance Power | 22 | 24 | 0 |

The total power minimum is less than the total power maximum because rolling resistance is subtractive against vehicle acceleration. As such, power required to decelerate a vehicle is typically less than power required to accelerate a vehicle at the same rate. Variances in the environment such as but not limited to surface grade, headwinds, and/or tailwinds can significantly alter the results.

FIG. 3 illustrates an electro-mechanically powered system 200. Particularly, system 200 comprises a power supply 23, electrical bus 33, electromechanical transmission 34, mechanical shaft 35, and a moveable or driven portion or assembly 24. Power supply 23 discharges and provides electrical power on bus 33. Electromechanical transmission 50 receives the electrical power from bus 33 and produces mechanical power on shaft 35. The movement portion 24 receives the power from the shaft 35 and in response to the receipt of the shaft power, is then selectively moved. If power supply 23 has the ability to absorb and store energy as well as supply energy, then the roles may be selectively reversed. That is, the selectively moveable assembly 24 may be made to provide mechanical power onto the shaft 35. Electromechanical transmission 50 receives the mechanical power from shaft 35 and produces electrical power on bus 33. The power supply 23 receives the electrical energy from bus 33 and is thus charged.

FIG. 4 illustrates how the general electromechanical power system of FIG. 3 could be adapted to a vehicle to meet the requirements of FIG. 1 and thus provide for or be adapted to comprise an electric power train. The power supply 23, in this example, comprises a battery 30. The electromechanical transmission 50, in this example, comprises an inverter 32, AC or “alternate current” bus 33, and electric motor generator 34. Bus 31 in this example is a DC or “direct current” bus and connects the battery 30 in power supply 23 to the inverter 32 in the electromechanical transmission 50. The assembly 24 in this non-limiting example is a vehicle, although it could be any type of selectively movable assembly. Only certain portions of this vehicle are shown in FIG. 4; those portions necessary for an understanding of the present invention(s). Shaft 35 connects the electric motor 34 in the electromechanical transmission 50 to the gearbox 36 in the assembly 24.

During operation, the battery 30 provides electrical power across DC bus 31 to inverter 32. The inverter 32 converts the DC power to AC or “alternating current type” power which is then transmitted across bus 33 to power the first motor-generator 34. The first motor-generator 34 provides rotational power to an input shaft 35 which is physically coupled to the selectively movement portion 24.

Shown is a driveshaft 35, gearbox and differential 36, output shafts 37 and 38, and wheels 39 and 40. The gearbox may include multiple selectable ratios and a differential. During deceleration, the first motor-generator 34 is able to apply a braking torque and act as a generator, receiving mechanical power from shaft 35 and generating AC electrical power onto bus 33. The inverter 32 is then able to convert the AC power on bus 33 into DC power on bus 31 which then recharges the battery 30. In an ideal system, the power supply can not only produce the required peak power of the total output power reference or portion 20 in FIG. 2, but it can also regenerate and store the energy released during the deceleration portion 3 of reference 20 in FIG. 2. In this non-limiting example, the battery 30 should be able to provide 209 kW of power and absorb 161 kW of power in order to meet the performance specification of FIG. 1. The battery 30 should also be able to charge and discharge much more energy due to transients than due to the sum of the motions. In a non-limiting example, the battery must discharge 10.3 kJ during acceleration and absorb 8.4 kJ during deceleration for a net energy loss of 1.9 kJ. Batteries of sufficient size can be created, but they are costly and each acceleration/deceleration discharge/charge cycle reduces life.

FIG. 5 illustrates the system of FIG. 4 with an altered power supply. The power supply 23 not only contains a battery 30, but also a flywheel 41, mechanical shaft 42, second motor generator 43, second AC electrical bus 44, and second inverter 45. A flywheel stores energy as kinetic energy of rotation. The flywheel 41 is charged when second inverter 45 receives DC electrical power from bus 31 and generates AC electrical power on bus 44. Second motor-generator 43 receives the AC electrical power from bus 44 and generates rotational power on mechanical shaft 42. The flywheel 41 receives the mechanical power from shaft 42 and accelerates. The flywheel 41 is discharged by reversing the process. Second motor-generator 43 applies a braking torque to shaft 42, which transmits that braking torque to flywheel 41. The deceleration of the flywheel 41 generates mechanical power on shaft 42. The second motor-generator 43 receives power from shaft 42 and creates AC electrical power on second AC electrical bus 44. Second inverter 45 receives the electrical power from second AC electrical bus 44 and generates DC electrical power on DC bus 31.

There are several modes of operation as the flywheel 41 can be selectively charged or discharged, the battery 30 can be selectively charged or discharged, and the vehicle 24 can be selectively accelerated or decelerated. It should be realized that while we use the reference numeral “24” to refer to a vehicle, this reference is referring to the what has been described as the “movement portion” of the vehicle (e.g., the wheels, gearbox/differential portion, and needed couplings). In practice, the movement portion and the remainder of what is shown in FIGS. 4 and 5 may be operatively placed within a single vehicle or other type of selectively movable assembly.

Through judicious sizing of the components, the flywheel 41 can be selectively charged or discharged to supplement and hence reduce the power requirement of the battery 30. Referring back to FIG. 2, the system can be designed such that the flywheel 41 provides the power 21 to accelerate the mass of the vehicle, while the battery supplies only the power 22 required to overcome rolling resistance. During the deceleration step or portion 3 of the power cycle which is shown in FIGS. 2 and 3, the second motor-generator 43 can convert the recovered vehicle kinetic energy into flywheel 41 rotational energy in lieu of the battery 30 being recharged. In such a system as FIG. 5, the battery 30 power requirements can be significantly reduced and the battery 30 power cycling can be reduced. The following table summarizes certain aspects of the systems of FIG. 4 and FIG. 5 when adapted to power a vehicle through the cycle of FIG. 1.

| | FIG. 4 | FIG. 5 |
|---|---|---|
| First Motor-Generator Power (kW) | 209 | 209 |
| Second Motor-Generator Power (kW) | N/A | 178 |
| Flywheel Inertia (kg-m\hat{ }2) | N/A | 6.58 |
| Flywheel Initial Spd (RPM) | N/A | 7083 |
| Battery Discharge Power (kW) | 209 | 31 |
| Battery Charge Power (kW) | 161 | 0 |
| Battery Discharge Energy (kJ) | 10.3 | 1.9 |
| Battery Charge Energy (kJ) | 8.4 | 0 |
| Net Battery Discharge Energy (kJ) | 1.9 | 1.9 |

Referring back to FIG. 5, a limiting aspect of the system is that all of the power released from the flywheel must pass through the second motor-generator 43 and all power supplied to the vehicle must pass through the first motor-generator 34. In a non-limiting example, the power train requirement is 209 kW, the first motor-generator 34 requirement is 209 kW, and the second motor-generator 41 requirement is 178 kW. Also, to adapt the system of FIG. 4 to a high-speed flywheel, a reduction gear set might be required between the flywheel 41 and second motor-generator 43 to limit motor-generator speed.

FIG. 6 illustrates an embodiment of a power-split system as detailed in U.S. Pat. No. 4,233,858 which is fully and completely incorporated herein by reference, word for word and paragraph for paragraph. It incorporates the flywheel 41 into the electromechanical transmission 50. The electromechanical transmission 50 splits power between and electrical path and a mechanical path. The electrical path is formed by the first motor-generator 34, AC bus 33, first inverter 32, DC bus 31, second inverter 45, AC bus 44, and second motor-generator 43. The mechanical path is formed by the flywheel 41, shaft 42, planetary gear set 53, and shaft 57. The two paths are joined together at gear set 58. Since only a part of the mechanical power is transmitted along the electrical path, the motor-generators can be reduced in size relative to the system of FIG. 5. Also, since a mechanical path for mechanical power is typically more efficient than an electro-mechanical path (which involves a conversion of energy from mechanical to electrical back to mechanical), the system of FIG. 6 should be more efficient than the system of FIG. 5.

There are several disadvantages and limitations to the system of FIG. 6. One non-limiting example of such a limitation is that the flywheel 41 connects to the planetary gear set 53 by the use of ring gear 54. Flywheels store energy as kinetic energy of rotation. In a non-limiting example, a flywheel might spin at 7083 RPM. When a vehicle powered by the system of FIG. 6 is at rest, the carrier gear 55 is stationary and the ring gear 54 is spinning at the speed of the flywheel 41. The sun gear 56 is therefore counter-spinning at a speed proportional to the ratio of the gear set 53. In a non-limiting example with a ring gear 54 tooth count of 91 (NR=91) and a sun gear 56 tooth count of 31 (NS=31), the sun gear 56 and the first motor-generator 34 are counter spinning at 20,792 RPM. The first motor-generator 34 speed requirement is therefore extremely high, and the pinion speeds in the planetary gear set 53 are also extremely high. The speed effects could be mitigated with fixed-ratio reduction gear sets. Inserting a reducer gear set between the flywheel 41 and the ring gear 54 will reduce planetary gear set 53 component speeds and also the first motor-generator 34 speed. Inserting a reducer gear set between the first motor-generator 34 and the sun gear 56 will further reduce the first motor-generator 34 speed requirements.

Alternately, the flywheel 41 could be connected to the sun gear 56 to reduce planetary gear set 53 component speeds. With the flywheel 41 connected to the sun gear 56, the first motor-generator 34 could be connected to either the ring gear 54 or carrier 55. Both of these options reduce the mechanical torque multiplication of the torque generated by the first motor-generator 34. This can be mitigated by using a motor-generator with a higher torque rating. Alternately, a fixed ratio can be inserted between the first motor-generator 34 and the ring gear 54. Alternately, more power can be sent through the electrical path and less through the mechanical path.

Another limitation of the foregoing system is high-speed performance. As the vehicle accelerates, the speed of the planetary carrier 55 will increase as it is mechanically connected through gearbox 36 to the vehicle wheels 39 and 40. As energy is drawn out of the flywheel 41, it will decelerate. The increasing speed of the planetary carrier 55 together with the decreasing speed of the flywheel 41 act both singularly and in combination to decrease the counter-spin of the first motor-generator 34. At a certain point, the first motor-generator 34 will cease to counter-spin and begin to spin in the same direction as the flywheel 41. When that occurs, the first motor-generator 34 is no longer a generator but is now a motor. The system will now draw power from both the flywheel 41 and the battery 30. To prevent discharge of the battery 30, the second motor-generator 43 must cease motoring and act as a generator, drawing power from the output to provide energy to drive the first motor-generator 34 and/or recharge the battery 30. When this occurs, a circular power flow is created. That is, energy from the electrical system is converted to mechanical power by the first motor-generator 34, transmitted to the output shaft by the planetary gear set 53, converted back into electrical power by second motor-generator 43 and put back into the electrical system. This circular power through the gear set 53 increases the power requirement of various components such as the gear set and motors, and decreases system efficiency.

What is needed inter alia is an improved power assembly which provides the benefits of both the system of FIG. 4 and the system of FIG. 5 and the various embodiments of the present invention provide such benefits.

### SUMMARY OF THE INVENTION

It is a first non-limiting object of the present inventions to provide a hybrid assembly which overcomes all or some of the drawbacks of previous systems.

It is a second non-limiting object of the present inventions to provide a hybrid type of power-train which overcomes some or all of the drawbacks of previous systems.

It is a third non-limiting object of the present invention to provide a method for operating a selectively movable assembly which overcomes some or all of the drawbacks of previous selectively movable assemblies.

It is a fourth non-limiting object of the present invention to provide a flywheel operated power-train having features which make it suitable for the traditional vehicular consumer marketplace and which, by way of example and without limitation, allows a fly wheel to directly operate the wheels of a vehicle without the use of an internal combustion engine or battery.

It is a fifth non-limiting object of the present invention to provide a selectively movable assembly having a fly wheel operated power-train in which is adapted to utilize the fly wheel only during monitored vehicular situations in which the fly wheel operation is the most efficient of all available or utilized alternatives.

According to a first non-limiting aspect of the invention a selectively movable assembly is provided and includes a plurality of wheels; and a power-train comprising a flywheel and an engine and wherein each of said flywheel and said engine are selectively coupled to said plurality of wheels.

According to a second non-limiting aspect of the present invention, a selectively movable assembly is provided and includes a gearbox assembly; a pair of wheels which are coupled to the gear box assembly; a selectively rotatable flywheel which is selectively coupled to the gearbox assembly; a source of torque which is coupled to the gearbox assembly; and a control assembly which allows the flywheel to provide torque to the gearbox assembly at certain sensed speeds and which allows the source of torque to provide torque to the gearbox assembly at a speed above the certain sensed speeds.

According to a third non-limiting aspect of the present invention, a method of operating a selectively movable assembly is provided and includes the steps of providing a flywheel; providing a source of torque energy; and causing the flywheel to be solely operable only when the selectively movable assembly is at rest and only when the selectively movable assembly is travelling at speeds less than about twenty miles per hour.

These and other features, aspects, and advantages of the present invention(s) will become apparent from a reading of the Description of the Preferred Embodiment of the Invention, by a reading of The Claims, and by reference to the following drawings.

### BRIEF DESCRIPTION OF THE DRAWINGS

FIG. 1 is a graph illustrating speed versus time for a vehicle.

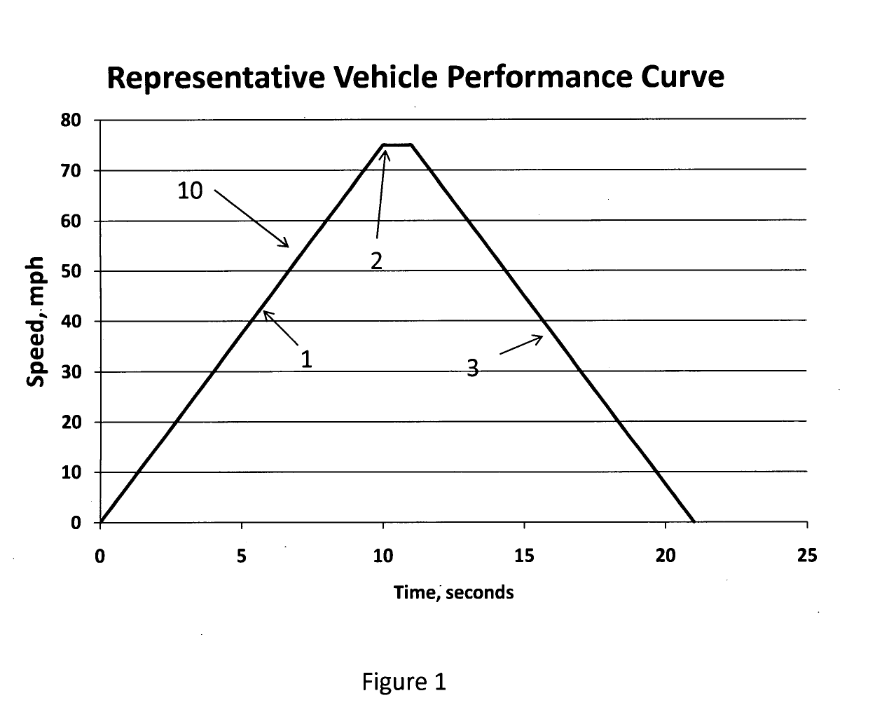

FIG. 2 is a graph illustrating power requirements of a vehicle.

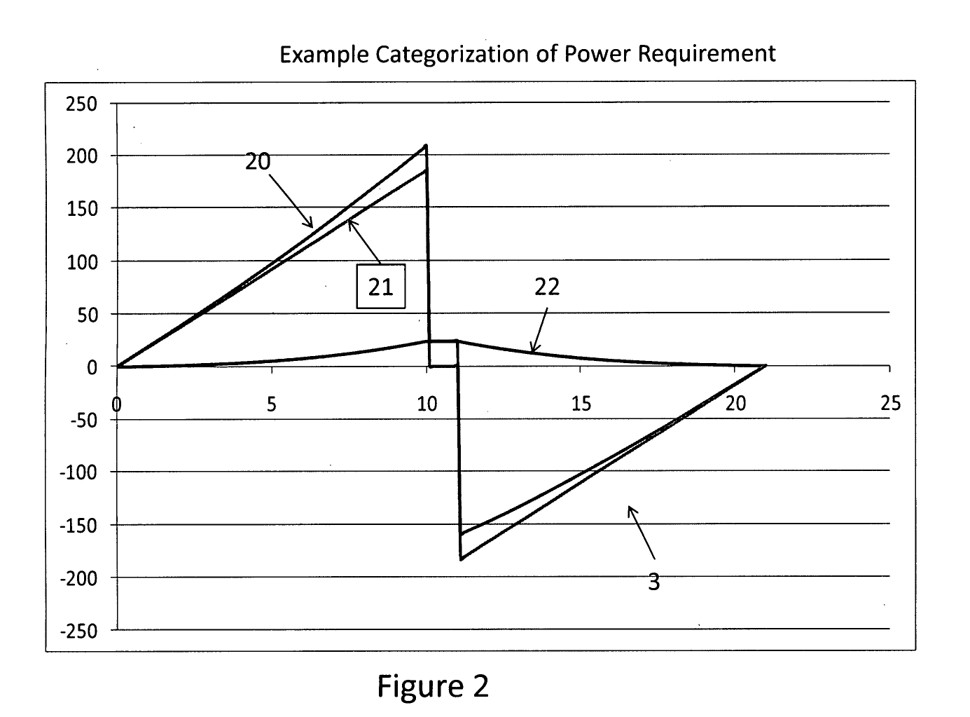

FIG. 3 is a block diagram of a vehicular electro-mechanical power system.

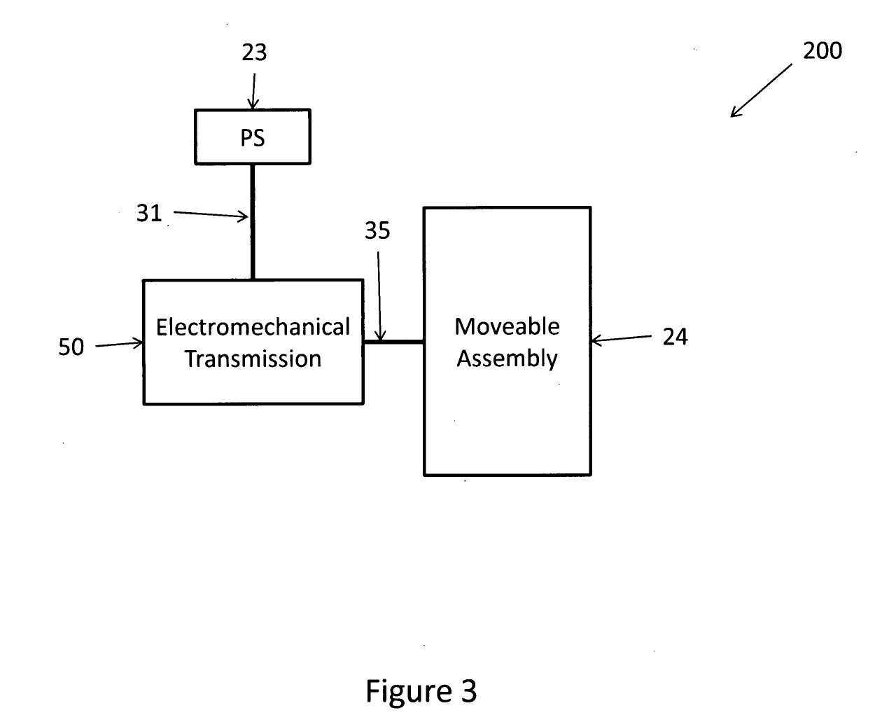

FIG. 4 is a block diagram of a second embodiment of a vehicular electro-mechanical power system.

FIG. 5 is a block diagram of a third embodiment of a vehicular electromechanical power system.

FIG. 6 is a block diagram of a fourth embodiment of a vehicular electro-mechanical power system.

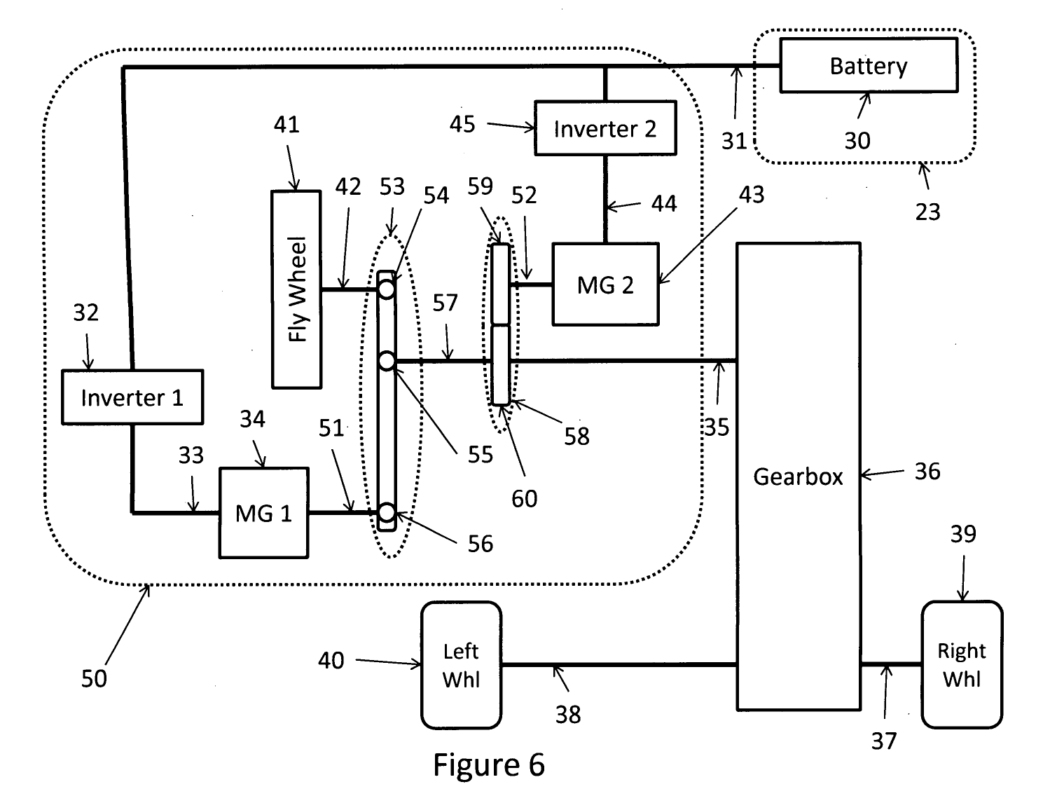

FIG. 7 is a block diagram of a vehicular electro-mechanical power system which is made in accordance with the teachings of the preferred embodiment of the present inventions.

FIG. 8 is a block diagram of an alternate embodiment of a vehicular electro-mechanical power-train system which is made in accordance with the teachings of an alternate embodiment of the present inventions.

FIG. 9 is a graph illustrating the operation of the assembly which is shown in FIG. 8 in a rapid acceleration mode.

FIG. 10 is a graph illustrating the operation of the assembly which is shown in FIG. 8 in a rapid deceleration mode.

FIG. 11 is a graphical illustration of the utilization of flywheel energy by the assembly which is shown in FIG. 8.

FIG. 12 is a block diagram of another alternate embodiment of a vehicular power-train system which is made in accordance with the teachings of the present inventions.

FIG. 13 is a block diagram of another alternate embodiment of a vehicular power-train system which is made in accordance with the teaching of the present inventions.

FIG. 14 is a block diagram of another alternate embodiment of a vehicular power-train system which is made in accordance with the teachings of the present inventions.

FIG. 15 is a block diagram of another alternate embodiment of a vehicular power-train system made in accordance with the teachings of the present inventions.

FIG. 16 is a block diagram of another alternate embodiment of a vehicular power-train system which is made in accordance with the teachings of the present inventions.

FIG. 17 is a block diagram of another alternate embodiment of the vehicular power-train system which is made in accordance with the teachings of the present inventions.

FIG. 18 is block diagram of another alternate embodiment of the vehicular power-train system which is made in accordance with the teachings of the present inventions.

FIG. 19 is a block diagram of another alternate embodiment of the vehicular power-train system which is made in accordance with the teachings of the present inventions.

### DETAILED DESCRIPTION OF THE PREFERRED EMBODIMENT OF THE INVENTION

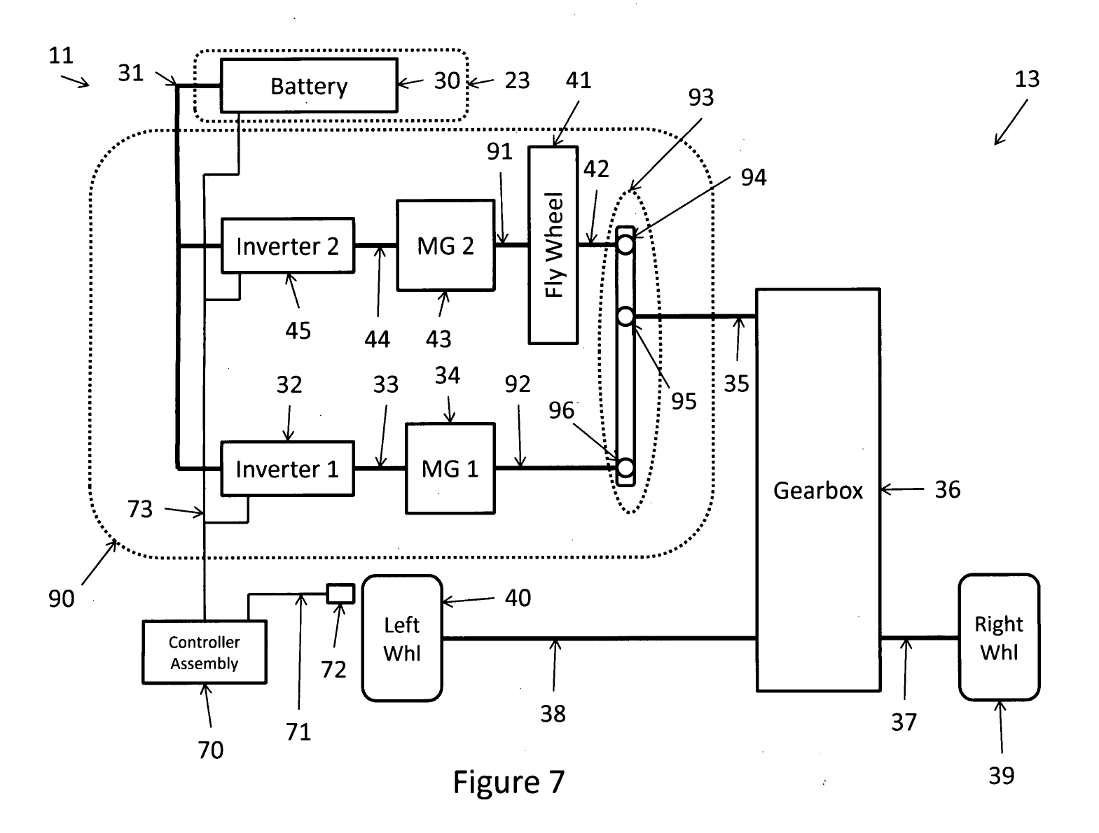

At the outset it should be realized that like reference numerals in the contained and referenced drawings are meant to refer to the same member, element, item or “thing” and that while the control assembly 70 is shown and described with reference to FIG. 7, the control assembly 70 exists within the systems of all of the other figures even though it may not be explicitly and pictorially shown and function to generally control the operation of the respective systems.

Referring now to FIG. 7, there is illustrated a selectively movable assembly 11 having a power-train system 13 which is made in accordance with the teachings of one of the preferred and non-limiting embodiment of the inventions.

Particularly, system 13 includes a transmission 90 with two motor-generators 34 and 43, two AC electrical busses 33 and 44, and two inverters 32 and 45. The transmission 90 also contains a flywheel 41 as well as a three-node planetary gear set 93 and a single output shaft 35. The planetary gear set 93 may comprise any conventional and commercially available planetary gear assembly with three nodes (or connection points) in order of increasing rotation 94, 95, and 96. The first motor-generator 34 interacts with planetary gear set 93 by being fixed for rotation with the third node 96 by shaft 92. The second motor-generator 43 is fixed for rotation with the flywheel 41 by being coupled to the shaft 91. As shown, the shaft 91 couples the flywheel 41 to the motor-generator 43. The flywheel 41 is also interacts with planetary gear set 93 by being fixed for rotation with the first node 94, by shaft 42. Transmission output shaft 35 interacts with planetary gear set 93 by being fixed for rotation to the second node 95.

The selectively movable assembly 11, which may or may not comprise a vehicle, further includes a gearbox or differential assembly 36 which is coupled to the shaft 35, and a left wheel 40 and a right wheel 39. The wheels 39, 40 are respectively coupled to the gearbox assembly 36 by the use of shafts 37, 38. It should be appreciated that the selectively movable assembly 11 may have a pair of other wheels (not shown) and that these not shown wheels are not directly “driven” or coupled to the gearbox assembly 36 the various inventions apply to selectively movable assemblies having a plurality of wheels or a single wheel or no wheels.

In the most preferred although non-limiting embodiment of the invention, the selectively movable assembly 11 also includes a speed sensor assembly 72 which is adapted to sense the speed of at least one of the selectively driven wheels 39, 30 and a controller 70 which is operable under stored program control and which is coupled to and which communicates with the speed sensor assembly 72 by the use of bus 71. The controller assembly 70 comprises a control processor assembly, such as and without limitation, a programmable logic controller assembly, and is coupled to the battery 30 by the use of bus 73 and such coupling allows operational power to be communicated to the controller 70. The controller assembly 70 may, optionally, include a “built in” sensor 72 or be operatively packaged to integrally include this sensing functionality and is further controllably coupled to the inverters 32, 45 by the use of bus 73 and the inverters 32, 45 are respectively coupled to the motor generators 34, 43 by the busses 33, 44. The controller assembly 70 is effective and is adapted to generate control signals upon the bus 73 which are effective to have the inverters 32, 45 respectively control the operation of motor generators 34, 43. That is, each motor generator 34, 43 may be respectively controlled and caused to be either a motor or a generator and such control emanates from the inverter to which it is respectively coupled. Each inverter 32, 45 is coupled to bus 31 and either or receives energy from the bus 31. Each inverter 32, 45 sends energy to bus 31 when the controlled motor generator 34, 43 is caused to act as a generator, and each inverter 32, 45 receives energy from bus 31 when the controlled motor generator 34, 43 is caused to act as a motor. The battery 30 is also coupled to bus 31 and acts in a passive manner sending energy to bus 31 when the voltage on bus 31 drops, or receiving energy from bus 31 when the voltage on bus 31 rises. As such, the battery 31 effectively sends or receives the sum of the energy received or sent by inverters 32, 45.

Controller assembly control signals are generated in response to the vehicle state and driver input, such information being obtained from various'sensors such as the speed sensor 72 and communicated to the controller assembly 70 by the use of buses such as bus 71.

In operation, before the selectively movable assembly 13 is moved, the flywheel 41 is “pre spun”. This is achieved by causing energy from the battery 30 which is communicated to the inverter 45 to be communicated to motor generator 43 and controller assembly 70 causes the motor generator 43 to function as a motor and to spin the fly wheel 41 by the use of the output shaft 91 of the motor generator 43. This motion is also transmitted to node 94 through shaft 42, causing it to rotate. As node 94 accelerates, reaction torques are generated at nodes 95 and 96 causing a forward output torque on shaft 35 and a reversing (counter-spinning) torque on shaft 92 and motor generator 34 respectively. Moreover, the amount of reaction torque which is present on nodes 95, 96 are proportional to the amount of inertia loads present on the nodes 95, 96 and any spin or frictional losses. Since the inertia of motor generator 34 is expected to be fractional of the inertia of the components connected to shaft 35 (is the vehicle), the expected result is that motor generator 34 counter-spins and the output 35 remains substantially at-rest.

When forward acceleration is desired at low speeds, motor generator 34 is caused to generate a forward torque which is communicated through shaft 92 to node 96. This forward torque resists the counter-spin of node 96 and connected components (which include shaft 92 and the motor generator 34 itself). This also generates reaction torques at nodes 95 and 94 which tend to accelerate the components connected to node 95 and decelerate the components connected to node 94. As node 96 is counter-spinning, motor generator 34 is acting as a generator and generating electrical power which is communicated to inverter 32 by use of bus 33 and then to bus 31.

The operation of motor generator 43 is selectable. It can be caused, through selective control of inverter 45, to act as a motor. In this “motor” mode it can draw a selective amount electrical power from bus 31 through inverter 45 and bus 44 and communicate this through shaft 91 to flywheel 41 and thus be effective at “recharging” the flywheel. Motor generator 43 can also, through selective control of inverter 45, be caused to act as a generator and resist the rotation of the flywheel. In this “generator” mode, it can draw a selective amount of mechanical power from the flywheel 41 through shaft 91 and communicate this as electrical power to bus 31 through bus 44 and inverter 45.

The operation of the battery is passive. It will attempt to regulate the voltage on bus 31 and will draw electrical power off as bus 31 voltage rises, and add electrical power to bus 31 as bus voltage falls. Hence the state of the battery is variable and dependent upon the amount of electrical power generated by motor generator 34 and the state of motor generator 43.

The torque generated at node 95 is communicated to the drive wheels 39, 40 through output shaft 35, gearbox 36, and axle shafts 37, 38 and is effective at driving the vehicle. If the motor generator 43 is caused to motor at identical power levels that motor generator 34 is generating, then the system will be powered solely by the flywheel 41. This is accomplished because the use of the flywheel 41 is highly efficient and the system is not limited by battery 30 power.

When forward deceleration is desired at low speeds, motor generator 34 is caused to generate a reverse torque which is communicated through shaft 92 to node 96. This reverse torque accelerates the counter-spin of node 96 and connected components. This also generates reaction torques at nodes 95 and 94 which tend to decelerate the components connected to node 95 and accelerate the components connected to node 94. As node 96 is counter-spinning, motor generator 34 is acting as a motor and consuming electrical power which is communicated from bus 31 through inverter 32 and bus 33 to motor generator 34. The operation of motor generator 43 is selectable as previously described and can either “motor” or “generate”. The operation of the battery is passive. The state of the battery is dependent upon the amount of electrical power consumed by motor generator 34 and the state of motor generator 43.

The torque generated at node 95 is communicated to the drive wheels 39, 40 through output shaft 35, gearbox 36, and axle shafts 37, 38 and is effective at driving the vehicle. If the motor generator 43 is caused to generate at identical power levels that motor generator 34 is consuming, then the system will be powered solely by the flywheel 41. This is accomplished because the use of the flywheel 41 is highly efficient and the system is not longer limited by battery 30 power.

The transition from “low speed” to “high speed” is dependent upon the speed of node 96. When the output 35 is at rest and the flywheel 41 is charged (spinning), node 96 is counter-spinning. As energy is drawn out of the flywheel 41 and/or output 35 speed increases, the counter-spin at node 96 will decrease and eventually cross through zero such that node 96 is no longer counter-spinning. At that point, “high speed” operation is achieved and the characteristics of the system change. The output speed at which this transition occurs is dependent upon gearing and control strategy, and can be adjusted by changing flywheel “pre-spin” and the amount of battery power used. One non-limiting example of such a transition speed in about twenty miles per hour. Speeds of twenty miles per hour are regarded as “low” speeds and other speeds are regarded as high speeds.

When forward acceleration is desired at high speeds (node 96 spinning in the forward direction), motor generator 34 is caused to generate a forward torque which is communicated through shaft 92 to node 96. This forward torque accelerates the forward-spin of node 96 and connected components (which include shaft 92 and the motor generator 34 itself). This also generates reaction torques at nodes 95 and 94 which tend to accelerate the components connected to node 95 and decelerate the components connected to node 94. As node 96 is forward-spinning, motor generator 34 is acting as a motor and consuming electrical power which is communicated from bus 31 through inverter 32 and bus 33 to the motor generator 34. The operation of motor generator 43 is selectable and can either “motor” or “generate”. The operation of the battery is passive. The state of the battery is variable and dependent upon the amount of electrical power consumed by motor generator 34 and the state of motor generator 43.

When forward deceleration is desired at high speeds (node 96 spinning in the forward direction), motor generator 34 is caused to generate a reverse torque which is communicated through shaft 92 to node 96. This reverse torque decelerates the forward-spin of node 96 and connected components (which include shaft 92 and the motor generator 34 itself). This also generates reaction torques at nodes 95 and 94 which tend to decelerate the components connected to node 95 and accelerate the components connected to node 94. As node 96 is forward-spinning, motor generator 34 is acting as a generator and generating electrical power which is communicated from bus 33 through inverter 32 and to bus 31. The operation of motor generator 43 is selectable and can either “motor” or “generate”. The operation of the battery is passive. The state of the battery is variable and dependent upon the amount of electrical power generated by motor generator 34 and the state of motor generator 43.

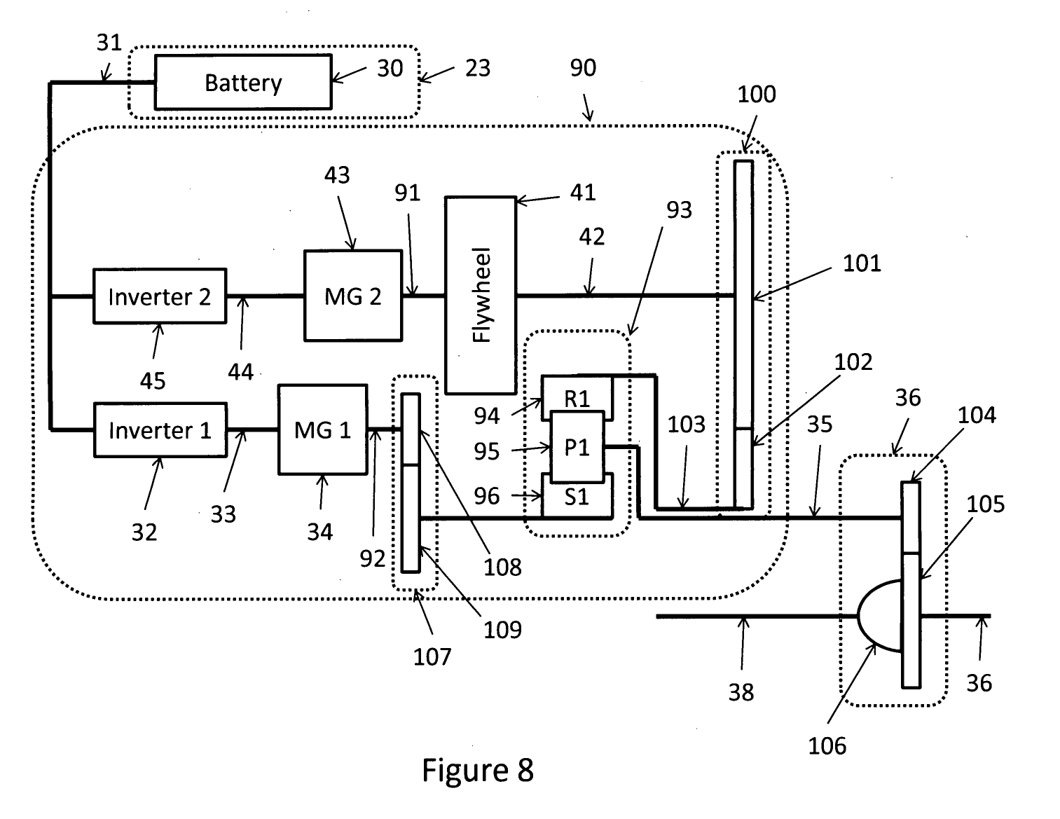

FIG. 8 illustrates a preferred although alternate embodiment of the system of FIG. 7. Reduction gear set 100 has been added to transmission 90 to limit the speeds of the components of the planetary gear set, 93. Particularly, the reduction gear set 100 is coupled to the shaft 42 from the flywheel 41. Reduction gear set 107 has been added to limit the speed of the first motor-generator 34. Particularly, the reduction gear set 107 is coupled to the shaft 92 of the motor generator 34. It should be understood that although reduction gear set 100 is between the flywheel 41 and planetary gear set 93 node 94, the flywheel 41 is still considered ‘fixed for rotation’ with planetary gear set 93 node 94 as they are fixed by a simple ratio. Similarly motor generator 34 is still ‘fixed for rotation’ with planetary gear set 93 node 96. The introduction of fixed ratio gear sets to manage component speeds, while useful, is not core to the invention.

The three node planetary gear set 93 may comprise a ring gear 94 in mesh with a plurality of pinions on a carrier 95 which are also in mesh with a sun gear 96. Planetary sun gear 96 is fixed for rotation with the output gear portion 109 of the reduction gear set 107. The input gear 108 of the reduction gear set 107 is in mesh with the output gear 109 and fixed for rotation with shaft 92. The input gear 101 of the reduction gear set 100 is fixed for rotation with the flywheel 41 by shaft 42 and is in mesh with the output gear 102. Moreover, the output gear 102 of the reduction gear set 100 is fixed for rotation with the ring gear 94 of the planetary gear set 93 by shaft 103. Gearbox 36 contains an input gear 104, output gear 105, and differential 106. The input gear 104 is fixed for rotation with the transmission output shaft 35 and is in mesh with output gear 105. The output gear 105 is fixed for rotation with the case of differential 106. The differential 106 provides for connections to outputs 38 and 36.

The system of FIG. 8 contains a mechanical power path through the gear set and an electrical path. The electrical path is comprised of the first motor-generator 34, the alternating-current or “AC” type bus 33, the first inverter 32, the direct current or “DC” type bus 31, then second inverter 45, the AC bus 44, and the second generator 43. The electrical path is not coupled to the output but instead coupled to the flywheel 41 through second motor-generator 43 and shaft 91.

The torque on transmission output shaft 35 is governed by the equation:

$${T}_{C} = \frac{{T}_{S} ( {N}_{R} + {N}_{S} )}{{N}_{S}} = \frac{{T}_{MG 1} {R}_{107} ( {N}_{R} + {N}_{S} )}{{N}_{S}}$$

Where T_{MG1}, T_{S} and T_{C} are the torque on the first motor generator 34, sun gear 96, and carrier 95 respectively, N_{R} and N_{S} are the number of teeth on the ring gear 94 and sun gear 96 respectively, and R₁₀₇ is the ratio of gear set 107. As can be seen, the torque on transmission output shaft 35 is solely determined by the torque of the first motor-generator 34.

The acceleration or deceleration of the flywheel 41 (hence its charge or discharge rate) is governed by:

$${α}_{FW} = \frac{{T}_{MG 2} - {T}_{R} {R}_{100}}{{J}_{FW}} = \frac{{T}_{MG 2} - {T}_{MG 1} {R}_{107} \frac{{N}_{R}}{{N}_{S}} {R}_{100}}{{J}_{FW}}$$

Where a_{FW} is flywheel 41 acceleration, T_{MG1} is first motor-generator 34 torque, T_{MG2} is second motor-generator 43 torque, T_{R} is ring gear torque, R₁₀₀ is the ratio of fixed ratio gear set 100, R₁₀₇ is the ratio of fixed ratio gear set 107, J_{FW} is flywheel 41 inertia, N_{R} is ring gear 94 tooth count, and N_{S} is sun gear 96 tooth count. The charge rate of the flywheel 41 rotational speed is thus proportional to the second motor-generator 43 torque and inversely proportional to the first motor-generator 34 torque. The flywheel 41 can be charged or discharged at any time without generating any output torque.

Through the judicious selection of the gear ratios for the planetary gear set 93 and the fixed ratio sets 100, 107, the system can be designed such that only a fraction of the power generated on shaft 35 is transmitted through the electrical path. The following table summarizes the design parameters for a preferred non-limiting example:

Planetary Gears

| | |
|---|---|
| Nr | 91 |
| Ns | 31 |

Fixed Ratios

| | |
|---|---|
| R100 | 4 |
| R107 | 1 |

Motor-Generators

| | Power | Trq | Base Spd | Top Spd |
|---|---|---|---|---|
| | kW | Nm | RPM | RPM |
| MG1 | 90 | 212 | 4050 | 7000 |
| MG2 | 90 | 212 | 4050 | 7000 |

Flywheel

| | | |
|---|---|---|
| weight | 200 | lbs |
| radius | 1.25 | ft |
| initial spd | 7083 | RPM |

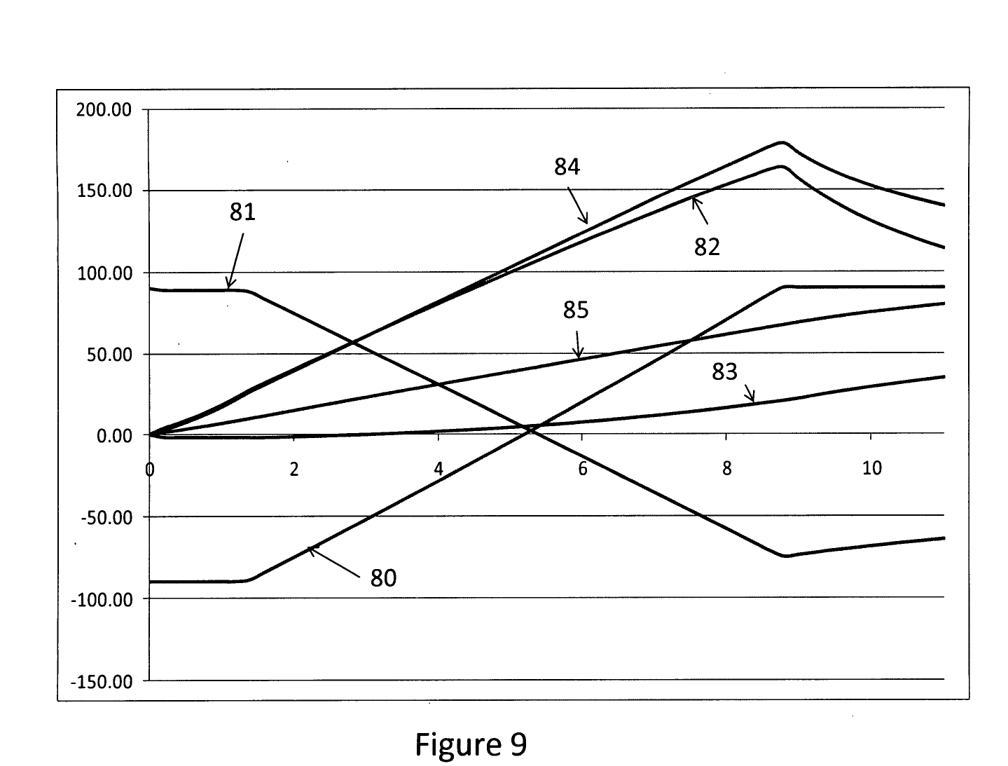

FIG. 9 illustrates a simulation of the preferred example during a rapid acceleration. Reference 80 is first motor-generator 34 power. Reference 81 is second motor-generator power 43. Reference 82 is flywheel 41 power. Reference 83 is battery 30 power. Reference 84 is output 35 power. Reference 85 is vehicle speed in mph. In this non-limiting example, output power 84 peaks at 178 kW while the battery power 83 never exceeds 22 kW at vehicle speeds below 75 mph. The following table summarizes select performance data:

| | | |
|---|---|---|
| Vehicle Weight | 3625 | lbs |
| Final Drive Ratio | 2.75 | |
| Tire Radius | 15 | in |
| 0-60 Time | 8 | sec |
| Peak Output Power | 178 | kW |
| Peak Battery Power (@ 75 mph) | 22 | kW |

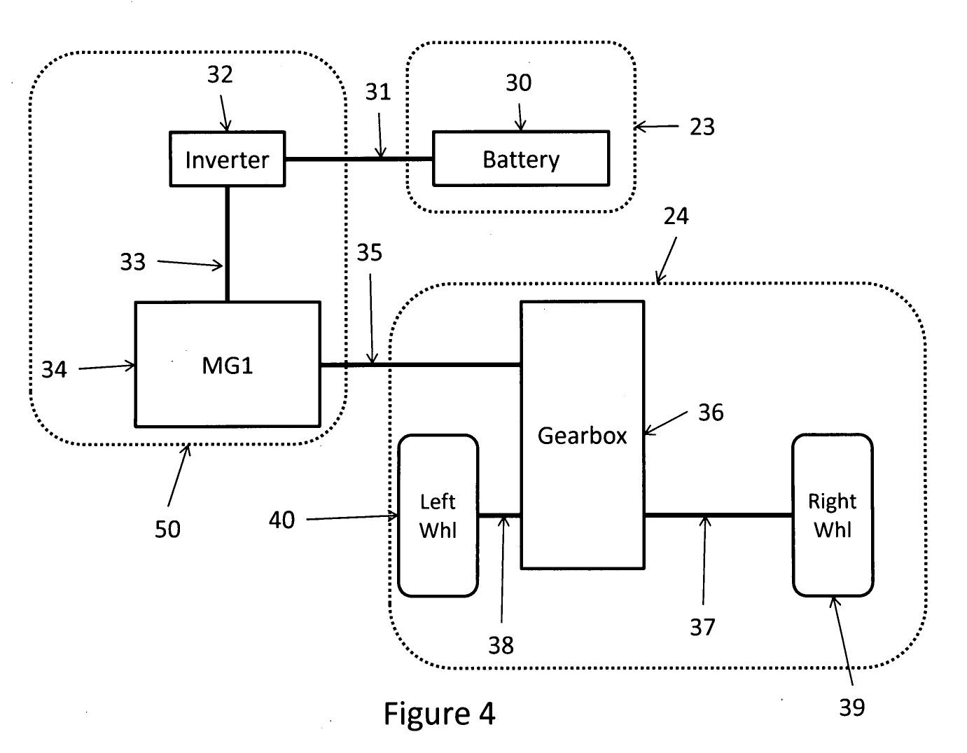

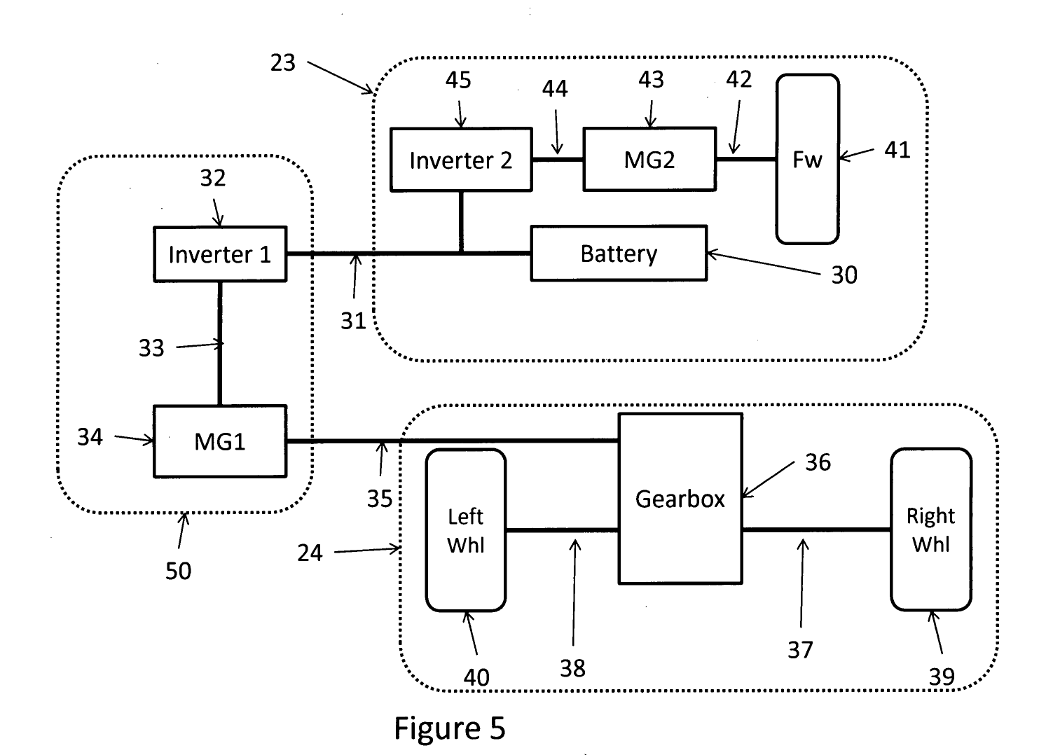

Note that the peak output power of the system of FIG. 8 is less than the peak power of the system of FIG. 4 or 5. This is due to the power peaking early (which also causes a non-linear acceleration). Realistic implementations of the systems of FIG. 4 or FIG. 5 could also have non-linear accelerations and thus reduced peak power requirements. This type of tradeoff is a typical part of vehicle design.

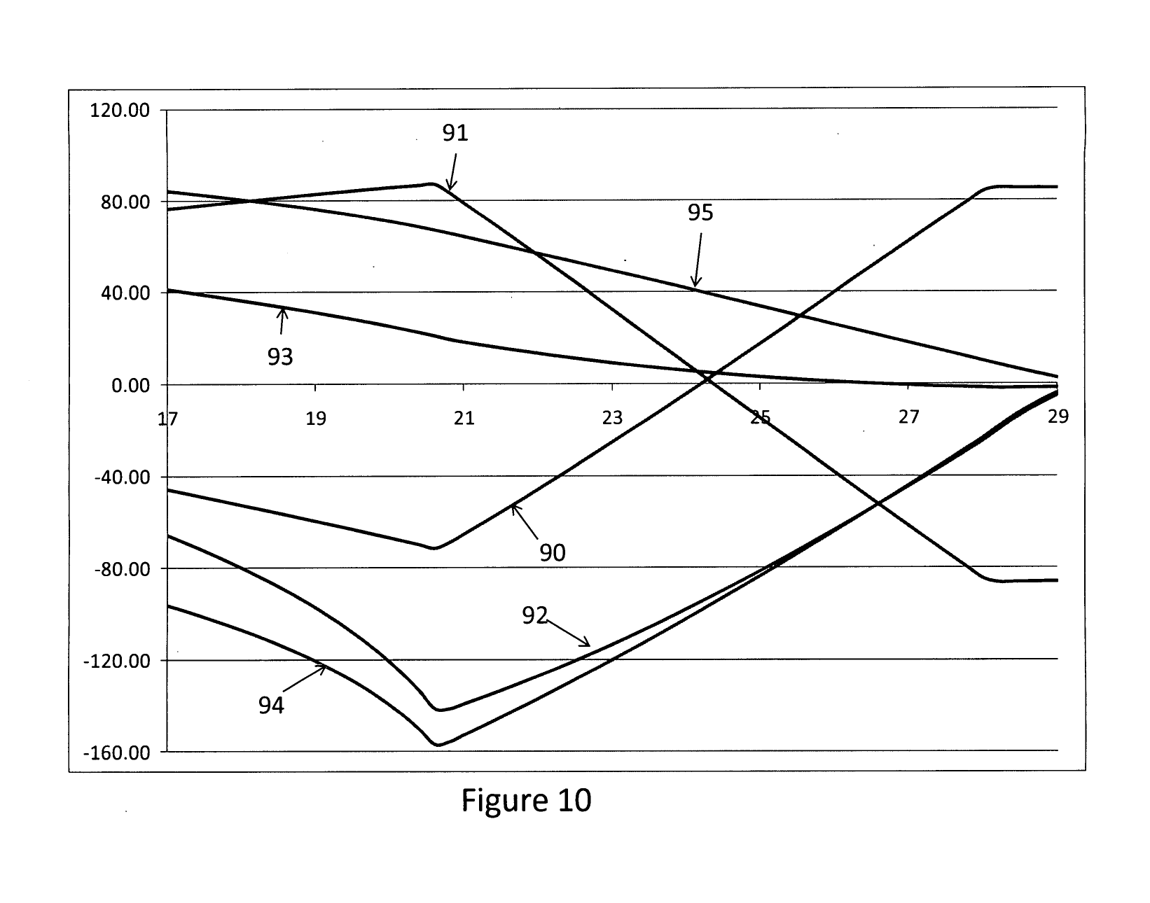

FIG. 10 illustrates a simulation of the preferred example during a rapid deceleration. Reference 90 is first motor-generator power. Reference 91 is second motor-generator power. Reference 92 is flywheel power. Reference 93 is battery power. Reference 94 is output power. Reference 95 is vehicle speed in mph. In this non-limiting example, the battery continues to discharge during deceleration.

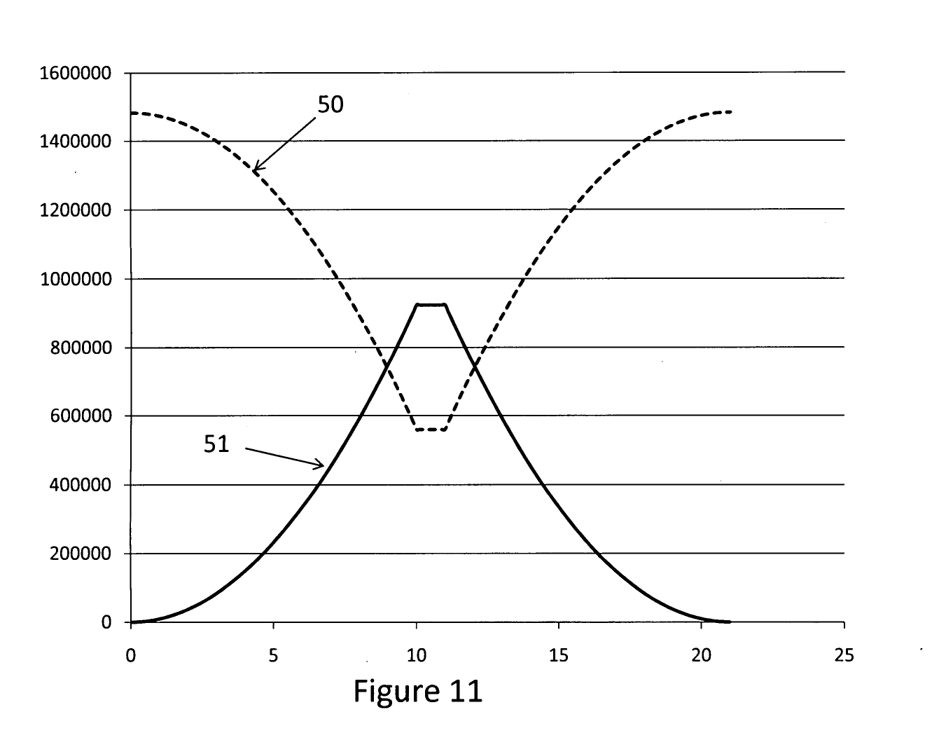

There are several approaches to sizing the flywheel and managing flywheel energy storage (i.e. flywheel speed). One approach is to size the flywheel for a certain vehicle top speed and manage flywheel energy storage based on vehicle speed such that the sum of vehicle kinetic energy and flywheel rotational energy is constant. FIG. 11 illustrates such a scheme. Reference 50 represents flywheel energy. Reference 51 represents vehicle kinetic energy. Alternately, the system could have several modes where the sum of the vehicle kinetic energy and flywheel rotational energy is constant, but the sum is different for each mode. Alternately, the flywheel energy could be a function of vehicle speed. Alternately, the flywheel energy could be a function of vehicle speed and desired output torque. If a flywheel of sufficient size and energy storage is used, it is possible to power the system solely from the flywheel, and the battery could be altogether removed.

It should be noted that there is a circular power flow in the system. Referencing FIG. 7, whenever first motor-generator 34 is acting as a generator, there is a power flow from the flywheel 41, into the planetary gear set 93 node 94, out of planetary gear set 93 node 96, through first motor-generator 34, through first inverter 32, through second inverter 45, through second motor-generator 43, and back into the flywheel 41. The amount of power in this loop is determined by the amount of power generated by the first motor-generator 34 and decreases as the generation action of first motor-generator 34 decreases. Typically, the power in this loop is maximal at a zero speed condition on shaft 35 and decreases as output shaft 35 speed increases. Once first motor-generator 34 ceases acting as a generator and acts as a motor, there is no longer a circular power flow.

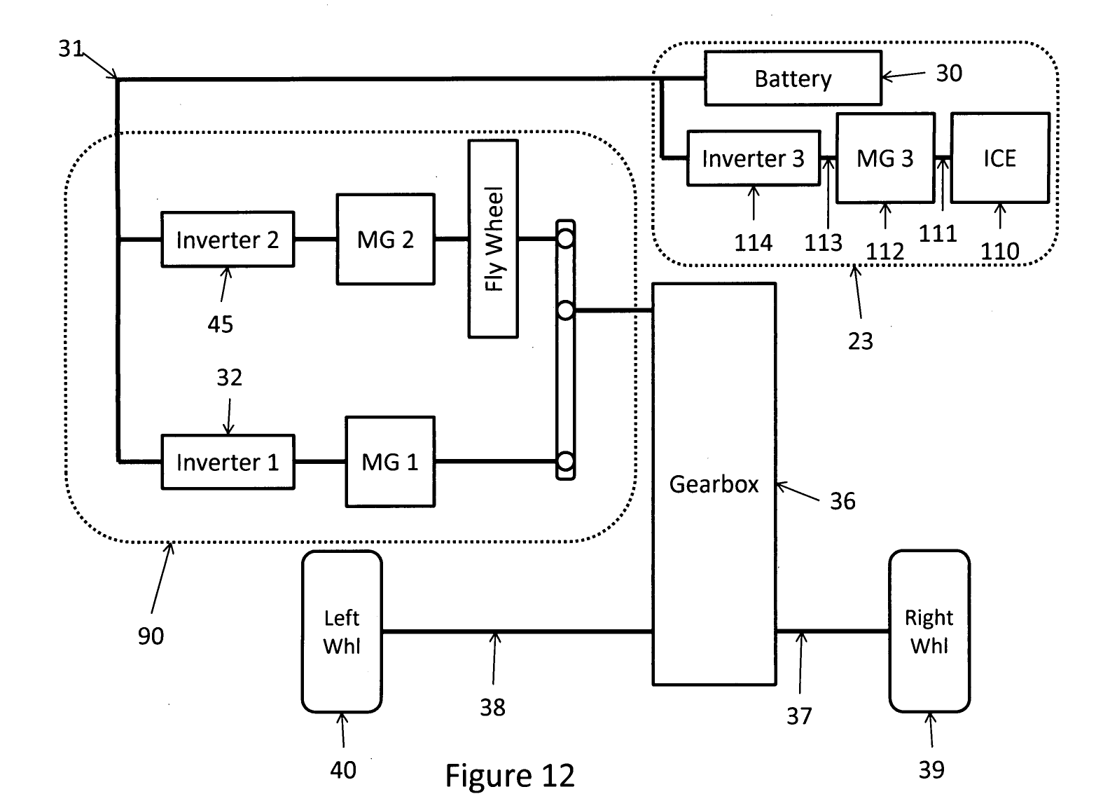

FIG. 12 illustrates how an internal combustion engine 110 can be added to the power supply 23 of the system of FIG. 7 to produce a series hybrid type of selectively movable architecture. The engine 110 provides mechanical power to shaft 111. Third generator 112 receives the mechanical energy from shaft 111 and generates alternating current type or “AC” electrical energy on bus 113. Third inverter 114 converts the AC electrical energy on bus 113 into direct current or “DC” type of electrical energy on bus 31. The energy provided on bus 31 could either provide power to first inverter 32, second inverter 45, and/or battery 30. Thus the engine can be used to drive the vehicle, recharge the battery 30, or accelerate and thus recharge the fly wheel inside the transmission 90.

The internal combustion engine 110 could be a gasoline engine. Alternately, the engine 110 could be a diesel engine. Alternately the engine 110 could be a gas-turbine engine.

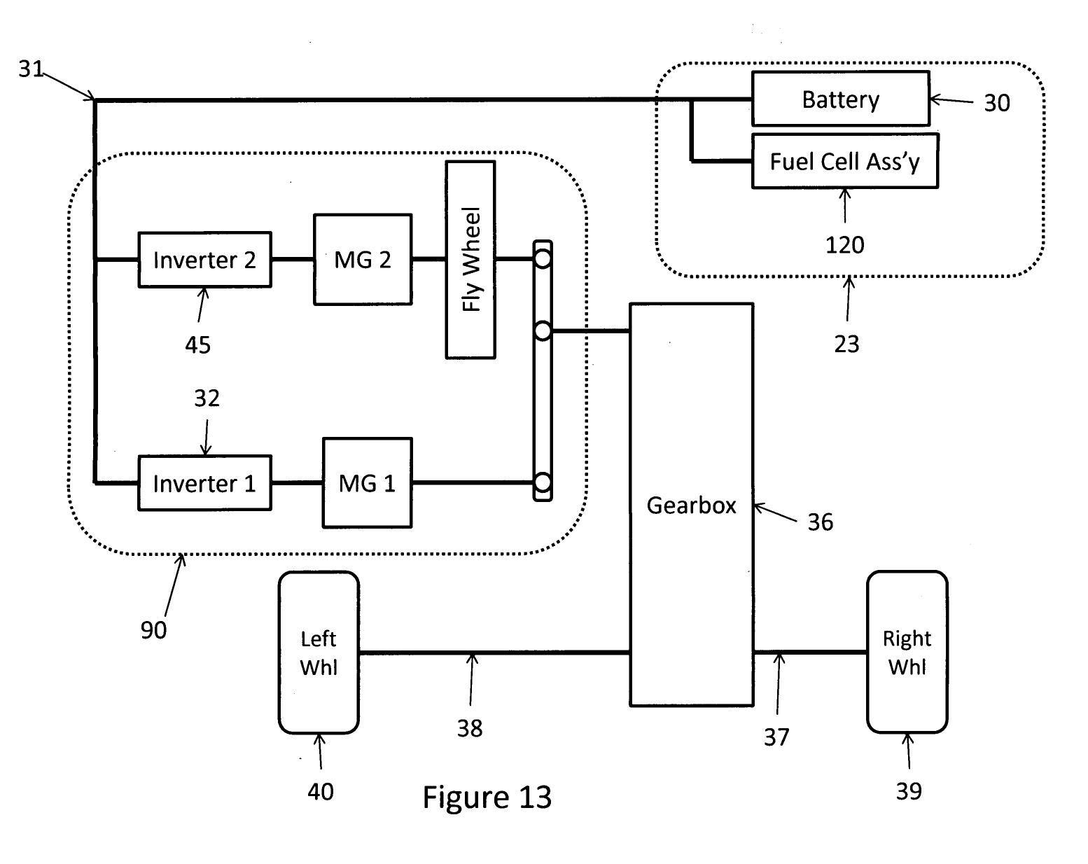

FIG. 13 shows how a fuel cell assembly 120 can be added to the power supply 23 of the system of FIG. 7. The fuel cell assembly 120 provides direct current or “DC” power directly to bus 31. It should be appreciated that the fuel cell assembly 120 and the internal combustion engine 110 each augment the energy supplied by the battery 30.

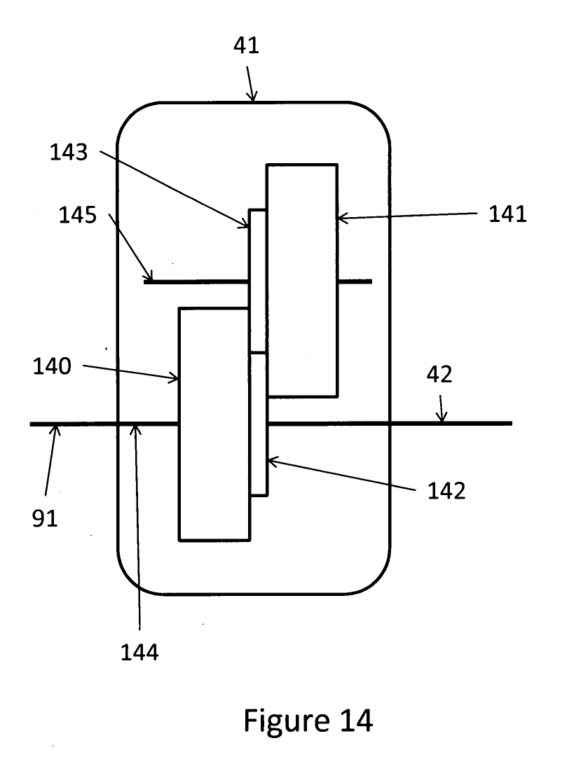

FIG. 14 shows how the rotating mass of the flywheel 41 from FIG. 7 or FIG. 8 can be split into two counter-rotating masses to limit the net gyroscopic forces. The flywheel assembly 41 contains, in this non-limiting example, a first flywheel 140 fixed for rotation with first gear 142 and a second flywheel 141 fixed for rotation with second gear 143 contained within housing 41. The gears 142 and 143 are in mesh. Second flywheel 141 and second gear 143 are mounted on second shaft 144 which is supported by bearings (not shown) supported by the housing 41. First flywheel 140 and first gear 142 are mounted on first shaft 144 which is supported by bearings (not shown) supported by the housing 41. First shaft 144 is fixed for rotation with input shaft 91 and output shaft 42. Alternately, first shaft 144 could be integrated with input shaft 91 and/or output shaft 42.

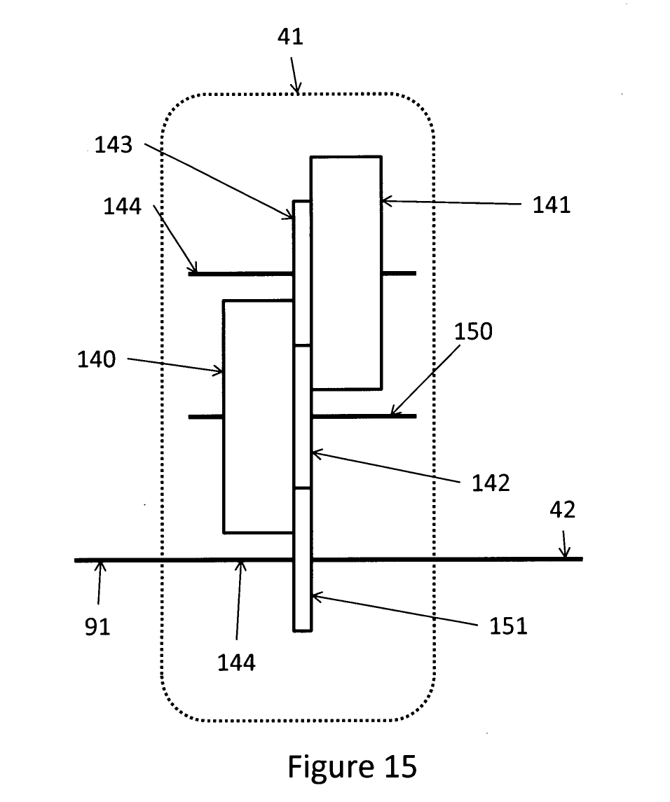

FIG. 15 shows how the rotating mass of the flywheel 41 assembly could be split and moved off-axis such that the second motor-generator fixed for rotation with shaft 91 could spin at a different speed than the flywheel 41 inertial masses. The flywheel 41 assembly contains a first flywheel 140 fixed for rotation with first gear 142, a second flywheel 141 fixed for rotation with second gear 143, and a third gear 151 contained within housing 41. The gears 142 and 143 are in mesh, and gears 151 and 142 are in mesh. Second flywheel 141 and second gear 143 are mounted on and fixed for rotation with second shaft 144 which is supported by bearings (not shown) supported by the housing 41. First flywheel 140 and first gear 142 are mounted on and fixed for rotation with third shaft 150 which is supported by bearings (not shown) supported by the housing 41. Third gear 151 is mounted on and fixed for rotation with first shaft 144, which is fixed for rotation with input shaft 91 and output shaft 42. Alternately, first shaft 144 could be integrated with input shaft 91 and/or output shaft 42.

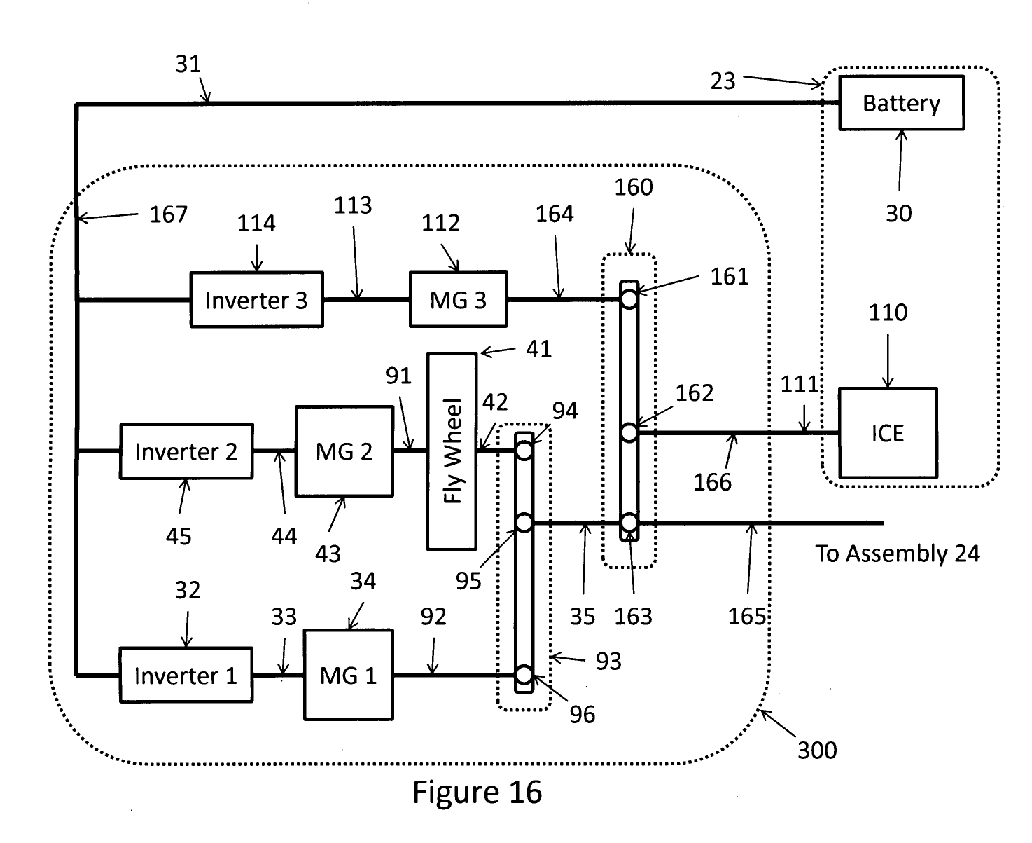

Referring now to FIG. 16, there is shown a system 300 which is made in accordance with the teachings of an alternate embodiment of the invention.

System 300 is a parallel-type hybrid transmission that has an electrical connection 167 which connects to an electrical portion of power supply 23 as well as a mechanical connection 166 which connects to a mechanical portion of power supply 23, as well as a single mechanical output 165. The power supply 23 contains a battery 30 to provide the electrical portion of the power, and an internal combustion engine 110 to provide the mechanical portion of the power. As will be explained, the system 300 of FIG. 16 can provide output power to shaft 165 by combinational use of the electric power supply 30, mechanical power supply 110, or flywheel 41 discharge power. It also can provide regenerative braking to shaft 165 by combinational recharge of the electric power supply 30 and/or recharge of the flywheel 41.

Particularly, the system 300 includes inverters 32, 45, and 114 which are each coupled to each other and to the electrical portion of power supply 23 by the bus 31. The system 300 further includes motor generators 34, 43, and 112 and the motor generators 34, 43, and 112 are respectively coupled to the inverters 32, 45, and 114 by the use of busses 33, 44, and 113. Further, the system 300 includes a flywheel 41 which is coupled to the shaft 91 of the motor generator 43 and which has an output shaft 42. The motor generator 34 has an output shaft 92.

Further, the system 300 includes the planetary gear set 93 and the shaft 42 is coupled to the ring gear portion 94 and shaft 92 is coupled to the sun gear portion, while shaft member 35 is connected to planetary carrier portion 95. The system 300 further includes a mechanical input shaft 166 which is connected to the mechanical portion of power supply 23 by shaft 111. The system 300 further includes a second planetary gear set 160 having a planetary gear portion 162 which is coupled to the shaft 166; a ring gear portion 161 which is coupled to the shaft 164; and a sun gear portion 163 which is coupled to the shaft 35. In the most preferred embodiment of the invention, the shaft 35 and sun gear 163 are coupled to the gearbox assembly 36 by shaft 165, which provides power to drive the wheels 39, 40.

In operation, when the selectively movable assembly 24 is not moving or at rest, then the flywheel 41 is charged by causing the motor generator 43 to act as a motor. In this manner, the flywheel 41 is rotated by shaft 91 and the battery will discharge as inverter 114 receives energy from bus 31. To prevent battery drawdown, internal combustion engine 110 can be selectively operated. With output 165 holding ring gear 163 at rest and the engine 110 through shaft 111 causing the carrier 162 to rotate, the sun gear 160 will be caused to rotate and along with it shaft 164 and motor generator 112. Inverter 114 can then through control of bus 113 cause motor generator 112 to resist rotation and act as a generator. The power received by inverter 114 from bus 113 will be transmitted to bus 31. If the power put on bus 31 by inverter 114 is equal to the power removed from bus 31 by inverter 45, the battery 30 will not discharge will the flywheel is charging. If the inverter 114 puts more power on the bus 31 than inverter 45 removes, then the battery 30 and flywheel 41 can both be simultaneously charged.

The effect of charging the flywheel 41 also causes ring gear 94 to rotate and sun gear 96 to counter-rotate. This will also generate a forward torque at the carrier 95 which will be transmitted to the output by shafts 35 and 165. The effect of motor generator 112 resisting sun gear 161 rotation will also generate a forward reaction torque at node 163, which will be transmitted to the output by shaft 165. The net result is a forward ‘creep torque’ on the output 165 while the flywheel is charging. This ‘creep torque’ could be negated by selective using motor generator 34 to generate a reversing torque on sun gear 96, which would create a reversing reaction torque at the carrier 95. This reversing torque could reduce or completely negate the forward ‘creep torque’ otherwise cased by charging the flywheel 41.

With the engine off, the system 300 behaves substantially identical to the system of FIG. 7. Motor generator 34 is caused to generate torque on node 96 through shaft 92. The torque on node 96 generates reaction torques on nodes 95 and 94 which produce output torque and charge/discharge the flywheel. Inverter 45 is independently selectively operated to cause motor generator 43 to also charge/discharge the flywheel 41 through shaft 91. The power consumer/generated by motor generator 43 is received from/transmitted to the inverter 45 by bus 44, and then from/to bus 31. The battery 30 remains a passive device, adding energy to bus 31 when the bus voltage drops, and removing energy when the bus 31 voltage rises.

A notable exception to the behavior of the system 300 is the operation of motor generator 112 while the engine is off and the vehicle is moving. To prevent excessive spin losses otherwise caused by allowing the engine to rotate while not operating, the sun gear 161 must be caused to counter-rotate relative to the ring gear 163 such that the carrier 162 remains stationary. During forward motion, when the ring gear 163 is forward spinning, the sun gear 160 must be reverse spinning. This is accomplished by using motor generator 112 to control the speed of the sun gear 161 (through shaft 164) to the appropriate speed such that sun gear 161 speed =ring gear 163 speed x −N_{R}/N_{S} where N_{R} and N_{S} are the number of teeth on the ring gear 163 and sun gear 161 respectively.

At any time during vehicle operation, the engine can be selective turn on. The engine will then generate a selective amount of forward toque on shaft 111 and then to the carrier 162. This torque at the carrier 162 will generate a forward reaction torque at the ring gear 163 and thus the output 165. A forward reaction torque will also be generated at the sun gear 161, which will cause the sun gear 161 to rotate, and along with it shaft 164 and motor generator 112. Inverter 114 must then selectively control motor generator 112 to resist the rotation and thus cause it to act as a generator. The power generated by motor generator 112 is received across bus 113 by inverter 114 and sent to bus 31.

During low-speed engine-on operation, motor generator 34 is acting as a generator and sending power to bus 31. This power is additive to the power sent by motor generator 112. This power can be used to charge the flywheel through selective control of motor generator 43. Any power not consumed by motor generator 43 will cause the battery to charge.

During high-speed engine-on operation, motor generator 34 is acting as a motor and consuming power from bus 31. This power is subtractive from power put on the bus 31 by motor generator 112. Motor generator 43 can be selectively controlled to consume or generate the difference between the power put on the bus by motor generator 112 and removed by motor generator 34.

In summary, the system 300 of FIG. 16 can provide output power by combinational use of the electric power supply, mechanical power supply, and/or flywheel discharge power. It also can provide regenerative braking by combinational recharge of the electric power supply and/or recharge of the flywheel. It is important to note that at any operating point, no matter if the engine is on or off, or output speed is low or high (i.e. motor generator 34 is generating or motoring), through judicious control of the motors 34, 43, 112, the battery 23 charge or discharge rate can be kept to zero, and hence the battery 23 could be removed from the power supply 23.

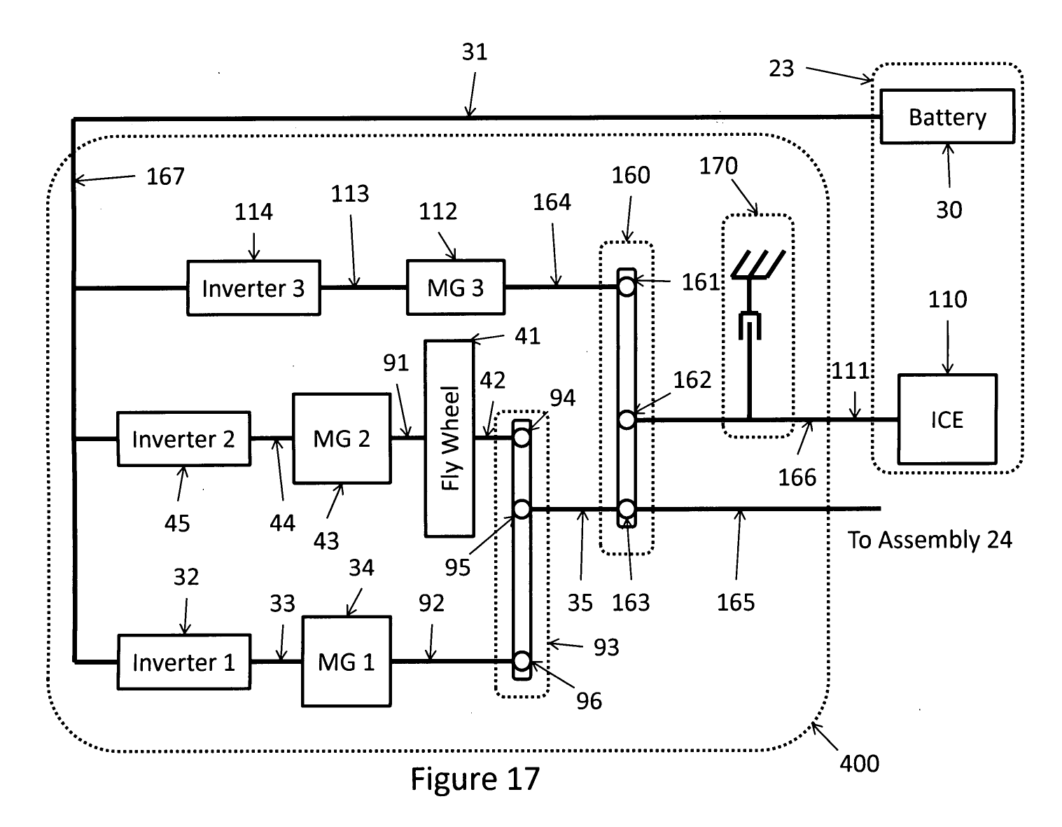

The system 400 of FIG. 17 is substantially similar to the system 300 of FIG. 16 except that a clutch 170 is coupled to the shaft 111. Clutch 170 can only be activated when the engine is off. With clutch 170 applied, it is possible to use motor generator 112 as a traction motor. This significantly changes the engine off behavior.

At low speeds (sun gear 96, shaft 92, and motor generator 34 counter-spinning) with the engine off and clutch 170 applied, inverter 114 controls motor generator 112 to generate a reversing torque on sun gear 161. With the carrier 162 held by clutch 170, the torque is reacted through the planetary gear set 160 and results in a forward torque on the ring gear 163, which is then transmitted to the output 165. Motor generator 34 generates a forward torque on sun gear 96. This results in a forward reaction torque at the carrier 95, which is also transmitted to the output. Since motor generator 34 is resisting a counter-spin, it is acting as a generator. By controlling the generation of motor generator 34 to match the consumption of motor generator 112, the system can run solely off the flywheel and not discharge the battery, and the ‘power loop’ as previously described no longer exists, so system efficiency is boosted.

Output torque and power can be increased by selectively increased by increasing the torque (and hence power generation) of motor generator 34. Motor generator 43 can then be selectively controlled to consume the difference between the power generated by motor generator 34 and the power consumed by motor generator 112. This re-introduces the ‘power loop’, but allows both motor generators 34 and 112 to act as launch devices, greatly increasing system 400 engine-off torque and power.

At high speeds (sun gear 96 forward-spinning) with the engine off and clutch 170 applied, inverter 114 controls motor generator 112 to generate a reversing torque on sun gear 161, and inverter 32 controls motor generator 34 to generate a forward torque on sun gear 96. These result in forward torques on ring gear 163 and carrier 95 respectively, which are additively transmitted to the output 165. During this type of operation, both motor generators 34 and 112 are consuming power. To prevent battery drawdown, motor generator 43 can be selectively controlled by inverter 45 to generate power equal to the consumption.

Since both motor generators 34 and 112 can be used to launch and drive the system 400, it is clear that either the motors can be downsized relative to the system of FIG. 16, or the system 400 can be used to power a much larger vehicle.

Similar to the system 300 of FIG. 16, the system 400 of FIG. 17 provides output power to shaft 165 by combinational use of the electric power supply 30, mechanical power supply 110, and/or flywheel 41 discharge power. It also provides regenerative braking to shaft 165 by combinational recharge of the electric power supply 30 and/or recharge of the flywheel 41. Also, at any operating point described above, through judicious control of motor generator 43, the system can be controlled and operated such that the battery 30 neither chares nor discharges, and thus the battery 30 could be removed.

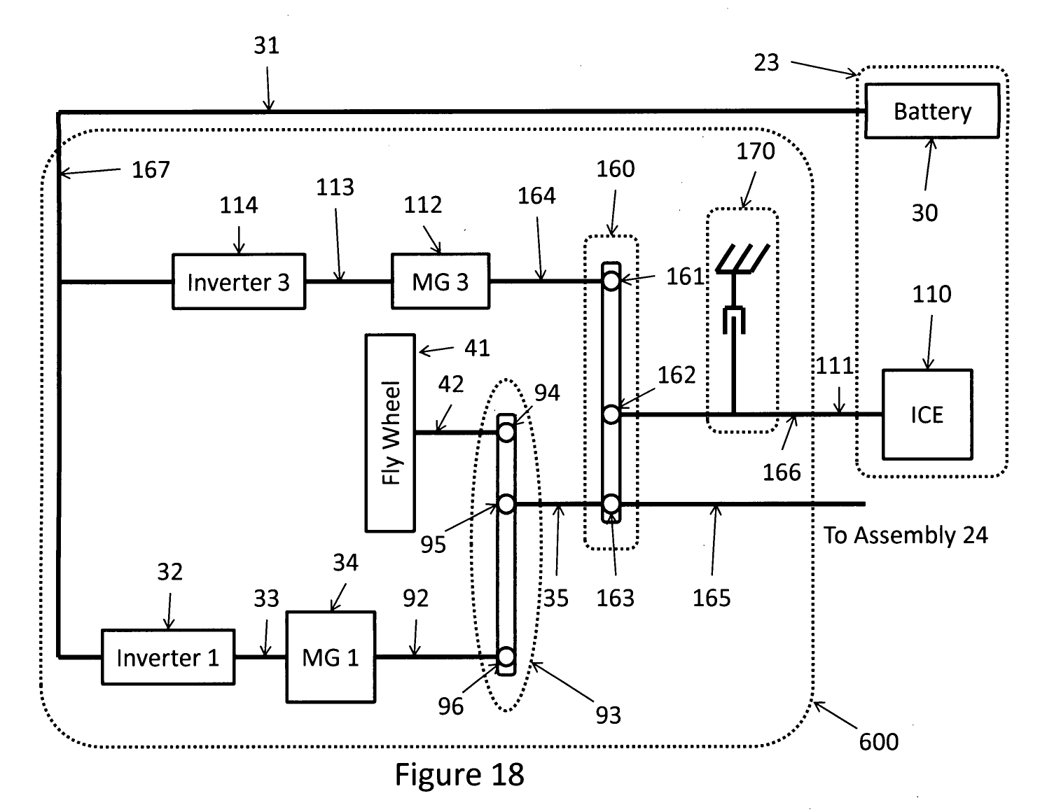

Referring now to system 600 as shown in FIG. 18, there is shown a parallel-type hybrid transmission that has an electrical connection 167 which connects to an electrical portion of power supply 23 as well as a mechanical connection 166 which connects to a mechanical portion of power supply 23, as well as a single mechanical output 165. The power supply 23 contains a battery 30 to provide the electrical portion of the power, and an internal combustion engine 110 to provide the mechanical portion of the power.

System 600 includes inverters 32, 114 which are coupled to the battery 30 portion of the power supply 23 by the bus 31. The system 600 further includes motor generators 34, 112 which are respectively coupled to the inverters 32, 114 by the busses 33,112. The system 600 further includes a flywheel 41 having an output shaft. The system 600 includes a first planetary gear set 93 having a sun gear portion 96 which is coupled to the output 'shaft 92 of the motor generator 34; a ring gear portion 94 which is coupled to the shaft 42; and a planetary gear portion 95 which is coupled to shaft 35.

The assembly 600 further includes a second planetary gear set 160 having a planetary gear portion 162 which is coupled to the mechanical portion of power supply 23 by shafts 166 and 111; a sun gear portion 161 which is coupled to the shaft 164 of the motor generator 112; and a ring gear portion 163 which is coupled to shaft 35 and shaft 165, and hence the assembly 24. System 600 further includes a clutch 170 which is coupled to the shaft 111.

In operation, during rest (e.g., when the assembly 600 remains stationary) the flywheel 41 can be charged solely by the battery 30. That is, power from the battery 30 is supplied to the inverter 32 which causes the motor generator 34 to become a motor and thus the shaft 92 begins to rotate. The rotational energy from the shaft 92 is transferred to the shaft 42 of the flywheel 41 through the planetary gear set 93. However, this creates a reverse reaction torque on the output shaft 165 and this causes the assembly 600 to travel in a backward direction if it is not in a “parked state”. In a vehicle, this “parked state” could be achieved by use of a parking brake, or by activation of the vehicle brakes. Alternatively, this reversing torque can be negated by use of motor generator 112 and clutch 170. Clutch 170 is applied and the motor generator 112 applies a reversing torque on sun gear 161 through shaft 164. This causes a forward reaction torque on ring gear 163, which is then transmitted to the output shaft 165. The net output torque on shaft 165 is then the difference between the forward torque generated at the sun gear 163 and the reverse torque generated at carrier 95. Through judicious application of torque by motor generator 112, the net torque on the output shaft 165 could be zero, or a positive ‘creep torque’, or even reverse ‘creep torque’ if it is desirable.

The flywheel 41 can also be charged by the engine 110 while the system 600 is at rest. The internal combustion engine 110 becomes activated and causes the shaft 111 to transfer torque at node or portion 162. This generates a forward reaction torque at sun gear 161, which causes the sun gear 161, shaft 164, and motor generator 112 to rotate. Motor generator 112 is made to resist rotation and function as a generator. The generated electricity is communicated through inverter 114, bus 31, inverter 32, and to motor generator 34. Motor generator 34 is made to function as a motor and apply a reversing torque on sun gear 96 through shaft 92. This generates a forward reaction torque ring gear 94 which is transmitted to the flywheel 41 through shaft 42, and thus the flywheel 41 accelerates and is charged.

The forward torque applied by the engine 110 to the carrier 162 also generates a forward reaction torque at the ring gear 163. This is then transmitted to the output shaft 165. The reverse torque applied by motor generator 34 to the sun gear 96 also generates a reverse reaction torque on the carrier 95, which is transmitted to shaft 35 and then to the output shaft 165. The net output torque on shaft 165 will be the difference between the forward torque from the ring gear 163 and the reversing torque from the carrier 95. During this method of flywheel 41 charging, external brakes such as a vehicle park brake or vehicle wheel brakes must be used to prevent undesirable movement.

After the flywheel 41 is charged, the internal combustion engine 110 may be deactivated (e.g., the shaft 111 ceases to rotate or move) and the flywheel 41 made to power the gearbox assembly 36. At low speeds, the sun gear 96, shaft 92, and motor generator 34 counter-spin. The motor generator 34 is made to resist the counter-spin by generating a forward torque on the sun gear 96. This generates a forward reaction torque at the carrier 95, which is transmitted to the output 165. This also generates a reverse reaction torque at node 94, which is transmitted to the flywheel 41 and causes the flywheel 41 to decelerate. Concurrently, clutch 170 is applied and motor generator 112 generates a reversing torque on ring gear 161. This generates a forward reaction torque at the ring gear 163, which is also transmitted to the output. By matching the power consumed by motor generator 112 to the power generated by motor generator 34, the system can run solely off of the flywheel 41, and the battery 30 will neither charge nor discharge as all of the power generated by motor generator 34 will be communicated through bus 33, inverter 32, bus 31, inverter 114, bus 113, and finally to motor generator 112.

The torque which is transferred to the output shaft 165 is communicated to the gearbox assembly 36, where it is used to selectively drive or move the wheels 39, 40. Thus, the selectively movable assembly 600 is being driven only by use of the flywheel 41.

At high vehicle speeds where the sun gear 93 ceases to counter-rotate and motor generator 34 generation capacity is reduced, then the internal combustion engine 110 is activated and the clutch 170 is disengaged. The engine 110 produces forward torque through shaft 111 onto the node or portion 162, which produces forward torque on the portion or node 163. This forward torque is transferred to the gearbox assembly 36 by the shaft 165, where it is used to selectively drive the wheels 39, 40. Concomitantly, forward torque is transferred to the node or portion 161 which causes the node 161, shaft 164, and motor generator 112 to rotate in the forward direction. Motor generator 112 is caused to generate a reversing torque to resist rotation and thus operate as a generator. The motor generator 112 supplies electrical power to the motor generator 34 through inverters 114, 32 and busses 33, 113, and 31. This electrical energy causes the shaft 92 to rotate and produce forward torque on the node or portion 96 which causes a forward torque on node or portion 95 which is communicated to shaft 165 through node or portion 163 and which supplements the torque provided by the internal combustion engine 110. This also generates a reverse reaction torque at node 94 which causes the flywheel 41 to decelerate.

While the system 600 is operating, the flywheel 41 can be recharged by the action of motor generator 34. Motor generator 34 is caused to generate a reverse torque on node 96, which generates a forward reaction torque on node 94. This forward torque on node 94 is transmitted to the flywheel 41 by shaft 42, and thus the flywheel 41 is caused to accelerate and is recharged. This reverse torque on node 96 also generates a reverse torque on node 95 which is transmitted to the output 165. To prevent a drop in output power during flywheel recharging, the engine 110 must apply a forward torque to the carrier 162, which generates a forward reaction torque at node 163. This reaction torque at node 163 must be sufficient to both power the vehicle and negate the reverse torque from node 95, or there will be a noticeable drop in output power while the flywheel is charging. Also, motor generator 34 and motor generator 112 should be caused to operate in a reciprocating fashion, that is the power consumed by one of the motor generators 34, 112, should match the power generated by the other of the pair or the battery will be caused to cycle.

In summary, similar to the system 300 of FIG. 16 and the system 400 of FIG. 17, the system 600 of FIG. 18 provides output power to shaft 165 by combinational use of the electric power supply 30, mechanical power supply 110, and/or flywheel 41 discharge power. It also provides regenerative braking to shaft 165 by combinational recharge of the electric power supply 30 and/or recharge of the flywheel 41. It should be noted that motor generator 112 can be caused to motor while the engine 110 is operation by controlling it such that it counter-spins (spins in the opposite direction as the engine 110). In this fashion, motor generator 112 can be caused to act as a motor while the engine is running so that motor generator 34 can act as a generator when needed, and the battery 30 may not be cycled and could be removed. But, the operating conditions at which the system 600 of FIG. 18 can operate without cycling the battery are generally much more narrow than the system 400 of FIG. 17.

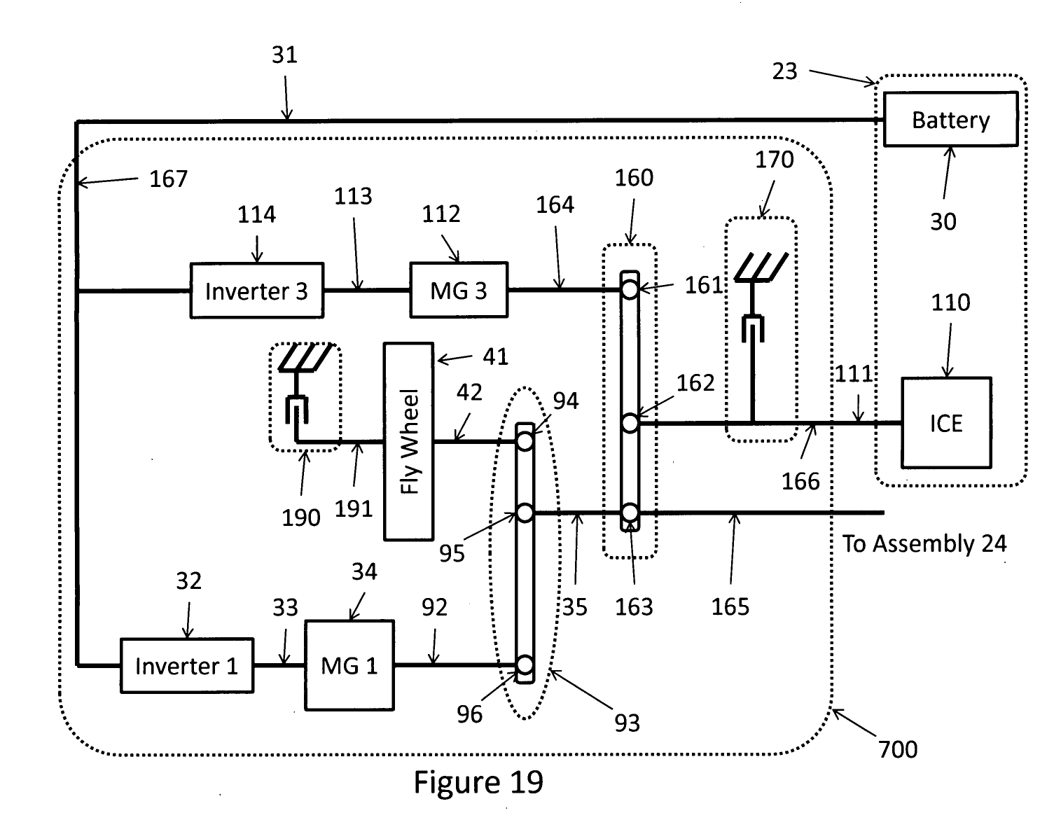

The system 700 of FIG. 19 is substantially similar to the system 600 of FIG. 18 except that a second selectively engageable clutch 190 is coupled to the flywheel 41 by shaft 191 and is engaged to stop the spinning of the flywheel 41. This is useful if it is necessary to operate the vehicle without waiting for the flywheel 41 to charge, and negates the risk of the flywheel 41 spinning backwards. It is also useful as a failsafe if the flywheel 41 becomes damaged or there is some other perceived danger associated with the spinning flywheel 41. The clutch assembly 190 could be any type of clutch typical of automatic transmissions. Clutch assembly 190 could also include a one-way-clutch for automatic engagement at zero-speed to prevent the flywheel 41 from ever counter-spinning. It should be noted that the clutch assembly 190 and shaft 191 could be added to any of the systems described herein to achieve the same function.

It should be appreciated that various non-limiting movable assembly embodiments have been described above which utilize a flywheel. In each of these embodiments, the flywheel 41 may be used to operate a selectively movable assembly during the time it is most efficient to do so (e.g., at relatively low speeds). Although at least one of these non-limiting embodiments allows the flywheel to operate the selectively movable assembly during normal operation. Further, it should be realized that the use of the metric “twenty miles per hour” to define the demarcation between a low speed and a high speed operation is for illustrative purposes only, and other speed metrics may be used.

It is to be understood that the inventions are not limited to the exact construction as set forth above, but that various changes and modifications may be made without departing from the spirit and slope of the invention as set forth in the following Claims.

What is claimed is:

1) A power-train comprising a flywheel which provides a mechanical energy path and an electrical energy path; and an output shaft which is coupled to said flywheel and wherein said flywheel is selectively accelerated and decelerated independent of the torque provided by said output shaft.

2) The system of claim 1 which also receives electrical power from an electrical power source, receives mechanical power from a mechanical power source, which can provide output power through combinational use of the said electric power supply, said mechanical power supply and said flywheel discharge power, and can provide regenerative braking through combinational recharge of the said flywheel and said electric power source.

3) The system of claim 1 comprising a flywheel, first three node planetary gear set, first motor generator, and second motor generator where said first motor generator and second motor generator are electronically coupled together, and where
a. said first motor generator is fixed for rotation with said third node of the first planetary gear set,
b. said second motor generator is fixed for rotation with said flywheel,
c. said flywheel is fixed for rotation with said first node of said first planetary gear set,
d. said mechanical output is fixed for rotation with said second node of said first planetary gear set.

4) The system of claim 3 where said first planetary gear set is a simple planetary gear set containing a first sun gear, first planet gear carrier, and first ring gear, where
a. said first node of said first planetary gear set is said first ring gear,
b. said second node of said first planetary gear set is said first planet gear carrier,
c. said third node of said first planetary gear set is said first sun gear.

5) The system of claim 6 with an electrical power source electrically coupled to said first motor generator and to said second motor generator.

6) The system of claim 1 with an electrical power source electrically coupled to said first motor generator and to said second motor generator.

7) The system of claim 1 which receives mechanical power from a mechanical power source, comprising a flywheel, first three node planetary gear set, second three node planetary gear set, first motor generator, second motor generator, and first brake clutch where said first motor generator and said second motor generator are electronically coupled together, and where
a. said first motor generator is fixed for rotation with said third node of the first planetary gear set,
b. said flywheel is fixed for rotation with said first node of said first planetary gear set,
c. said second motor generator is fixed for rotation with said third node of said second planetary gear set,
d. said mechanical power input is fixed for rotation with said second node of said second planetary gear set,
e. said mechanical output is fixed for rotation with said second node of said first planetary gear set,
f. said first node of said second planetary gear set is also fixed for rotation with said second node of said first planetary gear set,
g. said first brake clutch is operable on said second node of said second planetary gear set.

8) The system of claim 7 where said first planetary gear set is a simple planetary gear set containing a first sun gear, first planet gear carrier, and first ring gear, and said second planetary gear set is a simple planetary gear set containing a second sun gear, second planet gear carrier, and second ring gear, where
a. said first node of said first planetary gear set is said first ring gear,
b. said second node of said first planetary gear set is said first planet gear carrier,
c. said third node of said first planetary gear set is said first sun gear,
d. said first node of said second planetary gear set is said second ring gear,
e. said second node of said second planetary gear set is said second planet gear carrier,
f. said third node of said second planetary gear set is said second sun gear.

9) The system of claim 2 comprising a flywheel, first three node planetary gear set, second three node planetary gear set, first motor generator, second motor generator, and first brake clutch where said first motor generator and said second motor generator are electronically coupled together and coupled to said electrical power source, and where
a. said first motor generator is fixed for rotation with said third node of said first planetary gear set,
b. said flywheel is fixed for rotation with said first node of said first planetary gear set,
c. said second motor generator is fixed for rotation with said third node of said second planetary gear set,
d. said mechanical power input is fixed for rotation with said second node of said second planetary gear set,
e. said mechanical output is fixed for rotation with said second node of said first planetary gear set,
f. said first node of said second planetary gear set is also fixed for rotation with said second node of said first planetary gear set,
g. said first brake clutch is operable on said second node of said second planetary gear set.

10) The system of claim 7 where said first planetary gear set is a simple planetary gear set containing a first sun gear, first planet gear carrier, and first ring gear, and said second planetary gear set is a simple planetary gear set containing a second sun gear, second planet gear carrier, and second ring gear, where
a. said first node of said first planetary gear set is said first ring gear,
b. said second node of said first planetary gear set is said first planet gear carrier,
c. said third node of said first planetary gear set is said first sun gear,
d. said first node of said second planetary gear set is said second ring gear,
e. said second node of said second planetary gear set is said second planet gear carrier,
f. said third node of said second planetary gear set is said second sun gear.

11) The system of claim 1 which receives mechanical power from a mechanical power source, comprising a flywheel, first three node planetary gear set, second three node planetary gear set, first motor generator, second motor generator, third motor generator, and first brake clutch where said first motor generator, said second motor generator, and said third motor generator are electronically coupled together, and where
a. said first motor generator is fixed for rotation with said third node of said first planetary gear set,
b. said flywheel is fixed for rotation with said first node of said first planetary gear set,
c. said second motor generator is fixed for rotation with said flywheel,
d. said third motor generator is fixed for rotation with said third node of said second planetary gear set,
e. said mechanical power input is fixed for rotation with said second node of said second planetary gear set,
f. said mechanical output is fixed for rotation with said second node of said first planetary gear set,
g. said first node of said second planetary gear set is also fixed for rotation with said second node of said first planetary gear set,
h. said first brake clutch is operable on said second node of said second planetary gear set.

12) The system of claim 11 where said first planetary gear set is a simple planetary gear set containing a first sun gear, first planet gear carrier, and first ring gear, and said second planetary gear set is a simple planetary gear set containing a second sun gear, second planet gear carrier, and second ring gear, where
a. said first node of said first planetary gear set is said first ring gear,
b. said second node of said first planetary gear set is said first planet gear carrier,
c. said third node of said first planetary gear set is said first sun gear,
d. said first node of said second planetary gear set is said second ring gear,
e. said second node of said second planetary gear set is said second planet gear carrier,
f. said third node of said second planetary gear set is said second sun gear.

13) The system of claim 2 comprising a flywheel, first three node planetary gear set, second three node planetary gear set, first motor generator, second motor generator, third motor generator, and first brake clutch where said first motor generator, said second motor generator, and said third motor generator are electronically coupled together and coupled with said electrical power source, and where
a. said first motor generator is fixed for rotation with said third node of said first planetary gear set,
b. said flywheel is fixed for rotation with said first node of said first planetary gear set,
c. said second motor generator is fixed for rotation with said flywheel,
d. said third motor generator is fixed for rotation with said third node of said second planetary gear set,
e. said mechanical power input is fixed for rotation with said second node of said second planetary gear set,
f. said mechanical output is fixed for rotation with said second node of said first planetary gear set,
g. said first node of said second planetary gear set is also fixed for rotation with said second node of said first planetary gear set,
h. said first brake clutch is operable on said second node of said second planetary gear set.

14) The system of claim 13 where said first planetary gear set is a simple planetary gear set containing a first sun gear, first planet gear carrier, and first ring gear, and said second planetary gear set is a simple planetary gear set containing a second sun gear, second planet gear carrier, and second ring gear, where
a. said first node of said first planetary gear set is said first ring gear,
b. said second node of said first planetary gear set is said first planet gear carrier,
c. said third node of said first planetary gear set is said first sun gear,
d. said first node of said second planetary gear set is said second ring gear,
e. said second node of said second planetary gear set is said second planet gear carrier,
f. said third node of said second planetary gear set is said second sun gear.

15) A selectively movable assembly comprising a gearbox assembly; a pair of wheels which are coupled to said gear box assembly; a selectively rotatable flywheel which is selectively coupled to said gearbox assembly; a source of torque which is coupled to said gearbox assembly; and a control assembly which allows said flywheel to provide torque to said gearbox assembly at certain sensed speeds and which allows said source of torque to provide torque to said gearbox assembly at a speed above said certain sensed speeds.

16) The selectively movable assembly of claim 15 wherein said source of torque comprises an internal combustion engine.

17) The selectively movable assembly of claim 15 wherein said source of torque comprises a fuel cell.

18) The selectively movable assembly of claim 15 wherein said certain sensed speeds are less than about twenty miles per hour.

19) The selectively movable assembly of claim 15 wherein said control assembly only allows said flywheel to provide torque to said gearbox assembly at said certain speeds and when said flywheel is capable of providing said torque.

20) A method of operating a selectively movable assembly comprising the steps of providing a flywheel; providing a source of torque energy; and causing said flywheel to be operable only when said selectively movable assembly is at rest and only when said selectively movable assembly is travelling at speeds less than about twenty miles per hour.
